(19) United States
(12) Patent Application Publication
(10) Pub. No.: US 2023/0177439 A1
(43) Pub. Date: Jun. 8, 2023

(54) COMPUTER-EXECUTABLE APPLICATION FOR ORGANIZING A BUSINESS

(71) Applicant: Design for Scale LLC, Wayne, PA (US)

(72) Inventors: Christopher Clark, Wayne, PA (US); Jatin Malik, Bangalore (IN)

(73) Assignee: Design for Scale LLC, Wayne, PA (US)

(21) Appl. No.: 18/051,643

(22) Filed: Nov. 1, 2022

Related U.S. Application Data
(60) Provisional application No. 63/274,573, filed on Nov. 2, 2021.

(51) Int. Cl. G06Q 10/0637; G06Q 10/0639; G06Q 10/1093

(52) U.S. Cl. CPC G06Q 10/06375; G06Q 10/06393; G06Q 10/1095

(57) ABSTRACT

The system discussed herein are generally related to a computer-executable application to enhance the meeting experience and board meeting tasks in an organization. In particular, the embodiments discussed are related to a computer-executable application for analyzing, processing, and/or presenting data associated with an organization in a Board-of-Directors (BOD) environment.

### BACKGROUND OF THE INVENTION

Several public and private companies include a Board-of-Directors (BOD), which is a governing body of individuals that meet periodically to plan corporate management policies of the respective company. However, the members of conventional BOD meetings often perceive such meetings as sub-optimal because of time-consuming preparation, execution, and follow-up processes associated with such meetings. Additionally, the members may have a sub-optimal experience of the conventional BOD meetings because of various factors, such as, but not limited to, varying focus areas for discussions, subjectivity in opinions of members, varying expectations from members, and lack of collaboration applications for members.

It is a general perception among the BOD members that the BOD preparation, execution, and follow-up process provide a sub-optimal experience. Effectiveness of a BOD meeting may be defined as the combination of a feelings of BOD members and a tangible progress in supporting the company. Here, feelings of the BOD members may imply that the BOD members are enlightened, productive, contributory, and decisive on any decisions of the business as outlined in the agenda before the BOD meeting. Further, the tangible progress implies that these meetings build on previous meetings throughout the year to create a new layer of BOD competence and value addition for the next operating year.

Another consideration is that conventional BOD meetings often do not focus on capital allocation. The BOD meetings focus on sales and/or marketing but may not focus on how capital is being spent and if it is spent in the correct areas. Second, conventional BOD meetings do not have a continuous measurement or practice of comparing to a designated North Star(s) company as a part of the BOD agenda. There is no conventional BOD-related system that enables a private company to have a quarterly North Star progression application to follow a more dynamic and progressive BOD agenda that is always synced to strategy. Therefore, it is critical to overcome this challenge and it must be convenient and time efficient to create a transformative BOD experience for the BOD members.

Therefore, there is a need to optimize the experience of members in a BOD meeting.

### SUMMARY OF THE INVENTION

The system discussed herein are generally related to a computer-executable application to enhance the meeting experience and board meeting tasks in an organization. In particular, the embodiments discussed are related to a computer-executable application for analyzing, processing, and/or presenting data associated with an organization in a Board-of-Directors (BOD) environment.

### BRIEF DESCRIPTION OF THE DRAWINGS

Further advantages of the invention will become apparent by reference to the detailed description of preferred embodiments when considered in conjunction with the drawings, which should be considered non-limiting:

FIG. 1A shows an embodiment of a network environment.

FIG. 1B shows block diagrams of a computing device;

FIG. 2A illustrates a sign-up process for a BOD member on the application described in accordance with the embodiments presented herein.

FIG. 2B illustrates a live meeting module that displays various visuals visible to a BOD member during a BOD meeting.

FIG. 3 illustrates a home module that displays various options on a home screen when a BOD member launches the application on a computing device.

FIG. 4 illustrates a comps module that displays multiple details related to other companies.

FIG. 5 illustrates a tasks module, a calendar module, and a resources module that may be included in the application used by the BOD member.

FIG. 6 illustrates a search module, a notifications module, and an account module that may be included in the application.

FIG. 7 illustrates a specific company module that may be included in the application.

FIG. 8 illustrates a ‘log’ tab included in the specific company module.

FIG. 9 illustrates a sign-up process for a chief execute officer (CEO) of a company or an internal stakeholder of the company.

FIG. 10 illustrates a live meeting module that displays various visuals to a CEO or an internal stakeholder during a BOD meeting.

FIG. 11 illustrates a tasks module, a calendar module, and a resources module used by the CEO or an internal stakeholder of the company.

FIG. 12 illustrates a search module, a notifications module, and an account module used by the CEO or an internal stakeholder of the company.

FIG. 13 illustrates a home module used by the CEO or an internal stakeholder of the company.

FIG. 14 illustrates additional tabs in the home module used by the CEO or an internal stakeholder of the company.

FIG. 15 shows a system architecture overview.

FIGS. 16-69 (FIGS. 19A-19DA and 19DB, 25A-25F, 26A-26C, 38A-38D, 41A, and 41B are included in this brief description but FIGS. 19, 25, 26, 38, and 41 are not, as they do not exist) and the accompanying Demo Script show screenshots and a narrative describing screens using the system described herein.

### DETAILED DESCRIPTION

### 1. Introduction

1.2 Hardware Introduction

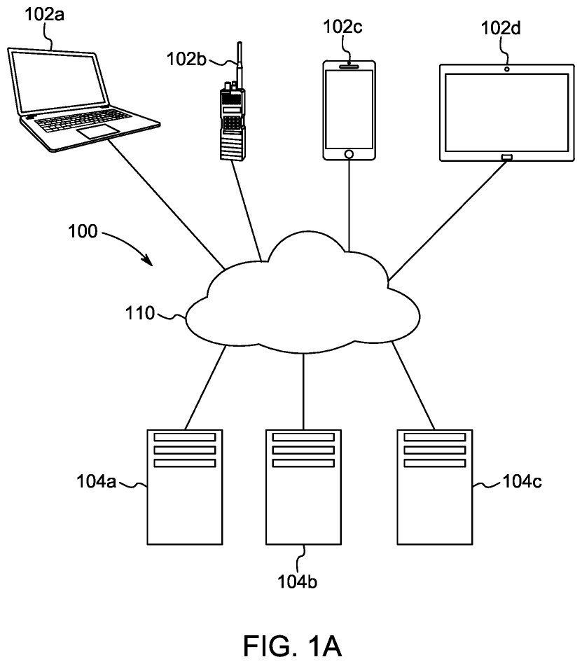

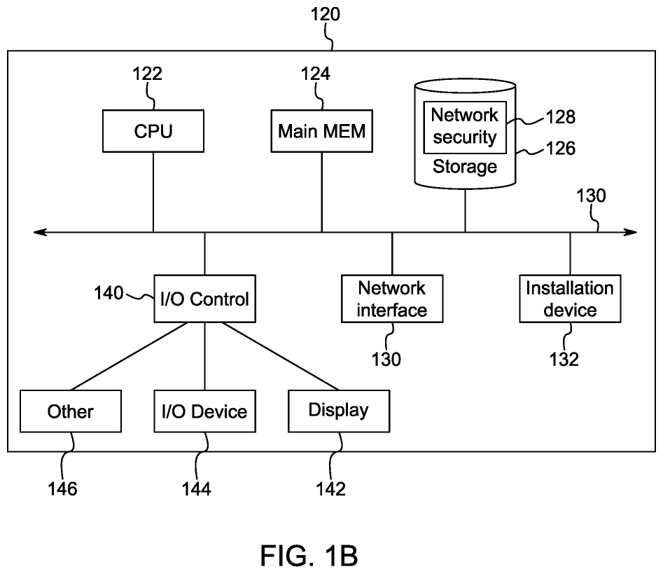

The system and method using the system and method described herein may be implemented using system and hardware elements shown and described herein. For example, FIG. 1A shows an embodiment of a network 100 with one or more clients 102a, 102b, 102c, 102d that may be local machines, personal computers, mobile devices, servers, tablets that communicate through one or more networks 110 with servers 104a, 104b, 104c. It should be appreciated that a client 102a-102c may serve as a client seeking access to resources provided by a server and/or as a server providing access to other clients.

The network 110 may be wired or wireless links. If it is wired, the network may include coaxial cable, twisted pair lines, USB cabling, or optical lines. The wireless network may operate using BLUETOOTH, Wi-Fi, Worldwide Interoperability for Microwave Access (WiMAX), infrared, or satellite networks. The wireless links may also include any cellular network standards used to communicate among mobile devices including the many standards prepared by the International Telecommunication Union such as 3G, 4G, and LTE. Cellular network standards may include GSM, GPRS, LTE, WiMAX, and WiMAX-Advanced. Cellular network standards may use various channel communications such as FDMA, TDMA, CDMA, or SDMA. The various networks may be used individually or in an interconnected way and are thus depicted as shown in FIG. 1A as a cloud.

The network 110 may be located across many geographies and may have a topology organized as point-to-point, bus, star, ring, mesh, or tree. The network 110 may be an overlay network which is virtual and sits on top of one or more layers of other networks.

A system may include multiple servers 104a-c stored in high-density rack systems. If the servers are part of a common network, they do not need to be physically near one another but instead may be connected by a wide-area network (WAN) connection or similar connection.

Management of group of networked servers may be de-centralized. For example, one or more servers 104a-c may include modules to support one or more management services for networked servers including management of dynamic data, such as techniques for handling failover, data replication, and increasing the networked server's performance.

The servers 104a-c may be file servers, application servers, web servers, proxy servers, network appliances, gateways, gateway servers, virtualization servers, deployment servers, SSL VPN servers, or firewalls.

When the network 110 is in a cloud environment, the cloud network 110 may be public, private, or hybrid. Public clouds may include public servers maintained by third parties. Public clouds may be connected to servers over a public network. Private clouds may include private servers that are physically maintained by clients. Private clouds may be connected to servers over a private network. Hybrid clouds may, as the name indicates, include both public and private networks.

The cloud network may include delivery using IaaS (Infrastructure-as-a-Service), PaaS (Platform-as-a-Service), SaaS (Software-as-a-Service) or Storage, Database, Information, Process, Application, Integration, Security, Management, Testing-as-a-service. IaaS may provide access to features, computers (virtual or on dedicated hardware), and data storage space. PaaS may include storage, networking, servers or virtualization, as well as additional resources such as, e.g., the operating system, middleware, or runtime resources. SaaS may be run and managed by the service provider and SaaS usually refers to end-user applications. A common example of a SaaS application is SALESFORCE or web-based email.

A client 102a-c may access IaaS, PaaS, or SaaS resources using preset standards and the clients 102a-c may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The clients 102a-c and servers 104a-c may be embodied in a computer, network device or appliance capable of communicating with a network and performing the actions herein. FIGS. 1A and 1B show block diagrams of a computing device 120 that may embody the client or server discussed herein. The device 120 may include a system bus 150 that connects the major components of a computer system, combining the functions of a data bus to carry information, an address bus to determine where it should be sent, and a control bus to determine its operation. The device includes a central processing unit 122, a main memory 124, and storage device 124. The device 120 may further include a network interface 130, an installation device 132 and an I/O control 140 connected to one or more display devices 142, I/O devices 144, or other devices 146 like mice and keyboards.

The storage device 126 may include an operating system, software, and a network user behavior module 128, in which may reside the network user behavior system and method described in more detail below.

The computing device 120 may include a memory port, a bridge, one or more input/output devices, and a cache memory in communication with the central processing unit.

The central processing unit 122 may be a logic circuitry such as a microprocessor that responds to and processes instructions fetched from the main memory 124. The CPU 122 may use instruction level parallelism, thread level parallelism, different levels of cache, and multi-core processors. A multi-core processor may include two or more processing units on a single computing component.

The main memory 124 may include one or more memory chips capable of storing data and allowing any storage location to be directly accessed by the CPU 122. The main memory unit 124 may be volatile and faster than storage memory 126. Main memory units 124 may be dynamic random access memory (DRAM) or any variants, including static random access memory (SRAM). The main memory 124 or the storage 126 may be non-volatile.

The CPU 122 may communicate directly with a cache memory via a secondary bus, sometimes referred to as a backside bus. In other embodiments, the CPU 122 may communicate with cache memory using the system bus 150. Cache memory typically has a faster response time than main memory 124 and is typically provided by SRAM or similar RAM memory.

Input devices may include smart speakers, keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include the same smart speakers, video displays, graphical displays, speakers, headphones, inkjet printers, laser printers, and 3D printers.

Additional I/O devices may have both input and output capabilities, including haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures.

In some embodiments, display devices 142 may be connected to the I/O controller 140. Display devices may include liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays.

The computing device 120 may include a network interface 130 to interface to the network 110 through a variety of connections including standard telephone lines LAN or WAN links (802.11, T1, T3, Gigabit Ethernet), broadband connections (ISDN, Frame Relay, ATM, Gigabit Ethernet, Ethernet-over-SONET, ADSL, VDSL, BPON, GPON, fiber optical including FiOS), wireless connections, or some combination of any or all of the above. Connections may be established using a variety of communication protocols. The computing device 120 may communicate with other computing devices via any type and/or form of gateway or tunneling protocol such as Secure Socket Layer (SSL) or Transport Layer Security (TLS). The network interface 130 may include a built-in network adapter, network interface card, PCMCIA network card, EXPRESSCARD network card, card bus network adapter, wireless network adapter, USB network adapter, modem or any other device suitable for interfacing the computing device 120 to any type of network capable of communication and performing the operations described herein.

The computing device 120 may operate under the control of an operating system that controls scheduling of tasks and access to system resources. The computing device 120 may be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein.

The computer system 120 may be any workstation, telephone, desktop computer, laptop or notebook computer, netbook, tablet, server, handheld computer, mobile telephone, smartphone or other portable telecommunications device, media playing device, a gaming system, mobile computing device, or any other type and/or form of computing, telecommunications or media device that is capable of communication.

In all of the hardware systems mentioned above, the method and system described herein may be embodied in some form and perform the functions explained herein through software, programmed hardware, or other computing means. The method and system described herein may also be done with some steps in software, and others done by a user.

1.2 System Introduction

The following detailed description is presented to enable a person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown but is to be accorded the widest possible scope consistent with the principles and features disclosed herein.

To overcome the challenges associated with the conventional BOD meeting, a computer-executable application helps systemize BOD meetings for all members and delivers a dynamic, energized, progressive, and decision-oriented Board meeting.

An objective of the embodiments herein may be to create a tool that encourages and captures best practices for preparing for and conducting a BOD meeting and accordingly, execute such best practices for effective and connected BOD meetings. Another objective of the embodiments presented herein may be to provide a framework for scoring each BOD meeting by members with respect to one or more parameters such as quality, acuity, efficiency, and/or depth of topics.

An additional objective of the embodiments presented herein may be to use real-time score card output for subsequent BOD meetings or any other meetings. Yet another objective may be to contextually link each BOD meeting to a subsequent BOD meeting with speed and convenience. Another objective of the embodiments presented herein may be to deliver dynamic scenarios of a company trend versus NorthStar cohorts. Another objective of the embodiments presented may be to enable selected content (e.g. cut and lift content) to be distributed to remaining employees of the company. Yet another objective of the embodiments may be to use the application for communication between members during a BOD meeting as well as integrate such communications to cloud storages, data sources, and commonly known communication applications.

The system described herein may be considered as a corporate and/or board member operating system that connects the running of a meeting to a building of a company with the key decision makers. As a system of record, a user can add anything to it, and its value grows at an increasing rate with increased use. It may be open and extensible using APIs (public comps, north star cohorts discussed below), it may connect people and resources together. It may deliver proprietary live presentation design and experiences on multiple form factors as mentioned below.

### 2. Example Scenarios

In an exemplary scenario, the computer-executable application presented herein may be implemented by private and venture-backed companies with approximately $5 million and above in revenue and employing a Board of Directors. In this example, companies with Boards who have accessed third party capital may implement the computer-executable application. However, a person skilled in the art would appreciate that revenue, market capitalization and/or other financial factors may not be necessary criteria to implement the embodiments presented herein, for a specific company and any number or type of factors may be considered without departing from the scope of the ongoing disclosure.

In another example, a fully onboarded customer using the application described herein may have the CEO, their direct reports including admin and a one or more additional users of the application in the Finance department. Additionally, there may be three to six users per Company Board. Over a period of time, there may be more users in a Company from the various functions who serve as team leaders. The application presented herein may enable increased collaboration between all stakeholders.

In the above example, a typical year one customer may include ten users of the application. This application may be the most important product used by a BOD member and one of the most important products for the CEO and company. Usage of the application may occur frequently and intensely before and after a BOD meeting versus just a few days before and during the BOD meeting. This application may act as a decision support application for the most important matters of the company.

### 3. Application

In accordance with the embodiments presented herein, the application may be executable on any known computing device such as, but not limited to, mobile phones, laptops, tablets, desktops, and so on. The application described in this disclosure may include at least four product components:

Component 1 (Sign up)—The first component may be a sign-up component that may allow a BOD member to login into the application, as will be described later.

Component 2 (Template or Frame of company)—The second component may include a template or a frame of, for example, but not limited, a three-year vision of a company. In an exemplary scenario, this component may include a table or text visual or to present associated data on the three years vision in a single view for conciseness. The three year vision may include the CEO's vision of key statements and metrics associated with the company. In another exemplary scenario, this data may also be included in an Office suite application document that articulates a target profile of the company in subsequent three years.

Component 3 (BOD Meeting Workflow)—The third component may include visuals and content inputs to prepare, perform, and follow-up a BOD meeting. In an exemplary scenario, there may be an information architecture depending on implementation requirements, as described later.

Component 4 (NorthStar module)—The fourth component may also be referred to as ‘ValuDash’ in an exemplary scenario. In the third component (BOD meeting workflow), there may be a codebase and a data set that may allow a user of the application to select a public company referred to as “NorthStar.” The application may allow the user (e.g. BOD member) to discover key metrics and compare performance of their company against the performance of the NorthStar(s) company that is selected. In an exemplary scenario, the Northstar module may present a data set of several public Software as a Service (SaaS) companies. This data may include financials, Key performance indices (KPIs), scraped qualitative insights, and CEO comments.

In an embodiment, the application may also optionally, include a modeling capability. For instance, the application may include a sales and marketing investment model that may allow the BOD members to toggle real-time, during or prior to a BOD meeting, several scenarios of growth to burn/profit trade-offs. This may resolve the conventional challenge with respect to capital allocation, thereby, changing a static BOD meeting into a more dynamic BOD meeting about strategic progression.

The application may provide an anchor of the company three-year vision that pivots each board meeting to associate their short term to long term objectives. The application may additionally provide a systemized technique for BOD preparation, execution, and follow-up from each quarterly meeting across multiple years. Additionally, the application may also provide self-selected NorthStar(s) for the company to track its performance relative to a benchmark.

An objective of the application may be to demonstrate to the BOD members that a gap or delta between their company with a capital of for example, but not limited to, $15 million or $25 million is not substantive with respect to a capital of a public company two years before IPO. An exemplary inference for a CEO from the application may be “it could be just two more years and X amount of capital additionally required to equal a Northstar size, two years before an IPO.” In this example, a subsequent objective realized by the CEO may be “What do we need to do now to get on that same line of growth and performance as the Northstar?” The conventional mechanisms to conduct BOD meetings do not offer a BOD package that resolves the above-described scenario in a consistent, easy, and progressive manner.

In another scenario, the application may present data using graphs, tables, capsules, side bars, or other creative art to transform the BOD meeting to an enlightened, energized, fun, and decision-oriented BOD meeting.

### 4. Information Architecture Modules

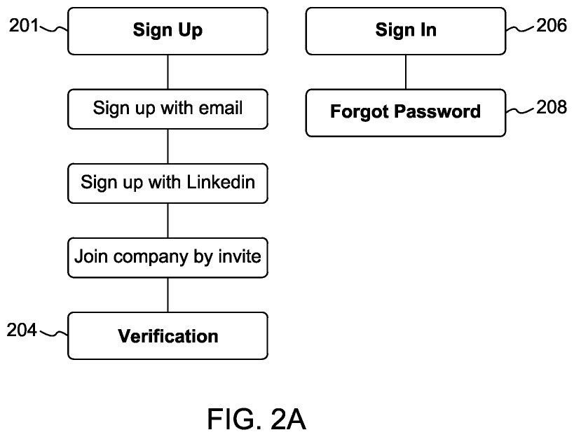

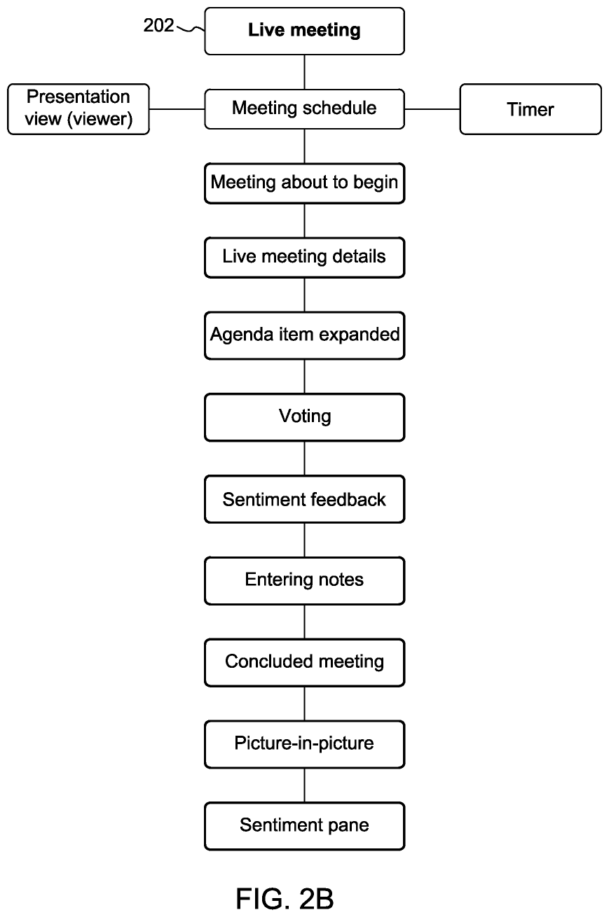

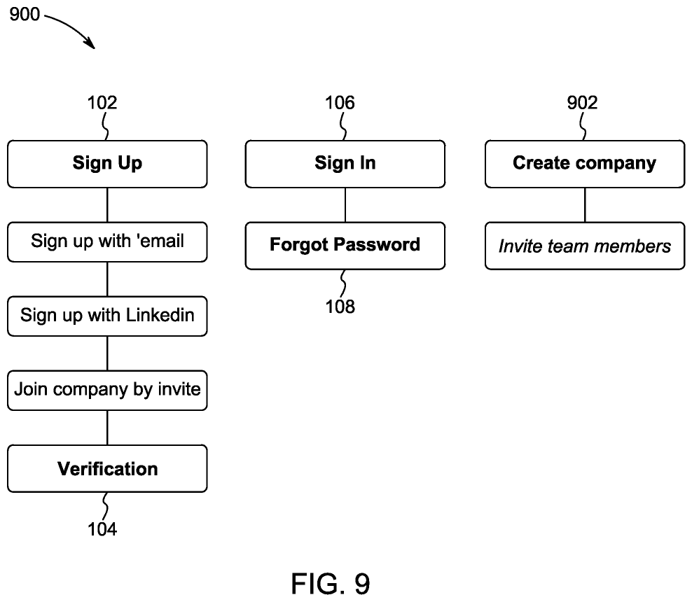

The methods and systems are described in more detail with reference to FIGS. 2A, 2B, and 3-14 and the document titled Feature Backlog attached hereto. FIGS. 2A, 2B, and 3-8 describe an information architecture when used or signed-in by a BOD member and FIGS. 9-14 describe an information architecture when used or signed-in by the CEO or an internal stakeholder.

FIG. 2A illustrates a sign-up process for a BOD member, on the application described in accordance with the embodiments presented herein. A BOD member may, for instance, sign up, in step 201 when they interact with the application for the first time. The sign-up process may be performed as per known methods of signing up a user on a computer application. For instance, the BOD member may sign up on the application using his email credentials, social networking credentials, or via a referral invite shared with them by another user of the application. In step 204, the application may successfully verify the BOD member to complete the sign-up process. In step 206, the BOD member who signed-up previously in step 204, may sign-in using the credentials used for signing-up. If the BOD member does not recall the correct credentials to sign-in, they may select a ‘forgot password’ option in step 208 and reset the password.

FIG. 2B illustrates a live meeting module 202 that is included in the application, to display various visuals visible to a BOD member during a BOD meeting. For instance, the live meeting module 202 may include a presentation viewer to display a slide-deck in a presentation view to the BOD members. The live meeting module 202 may additionally include a timer that indicates time elapsed since the meeting started. The live meeting module 202 may further include several options including, but not limited to, an indication that the BOD meeting is about to begin, live meeting details, an indication of an agenda item that is expanded, voting options, sentiment feedback, options to enter notes in the application, an indication that the BOD meeting is concluded, an option to switch the presentation view to a picture-in-picture (PIP) mode, and a sentiment pane.

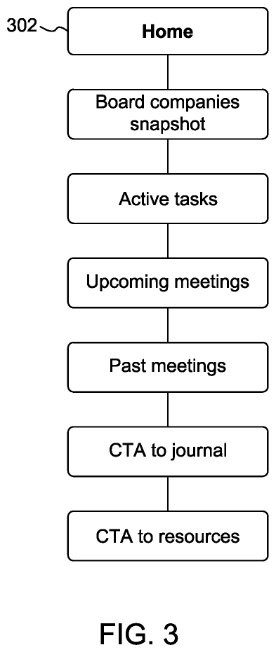

FIG. 3 illustrates a home module 302, included in the application, to display various options on a home screen when a BOD member launches the application on a computing device. As illustrated in this figure, the home module 302 may include a snapshot of various details associated with the BODs and/or the corresponding companies that the BOD member may be associated with. The home module 302 may additionally include a list of active tasks for the BOD members to plan or execute. The home module 302 may further include a list of upcoming meetings and past meetings. Further, the home module 302 may include a call to action (CTA) to journal and a CTA to resources.

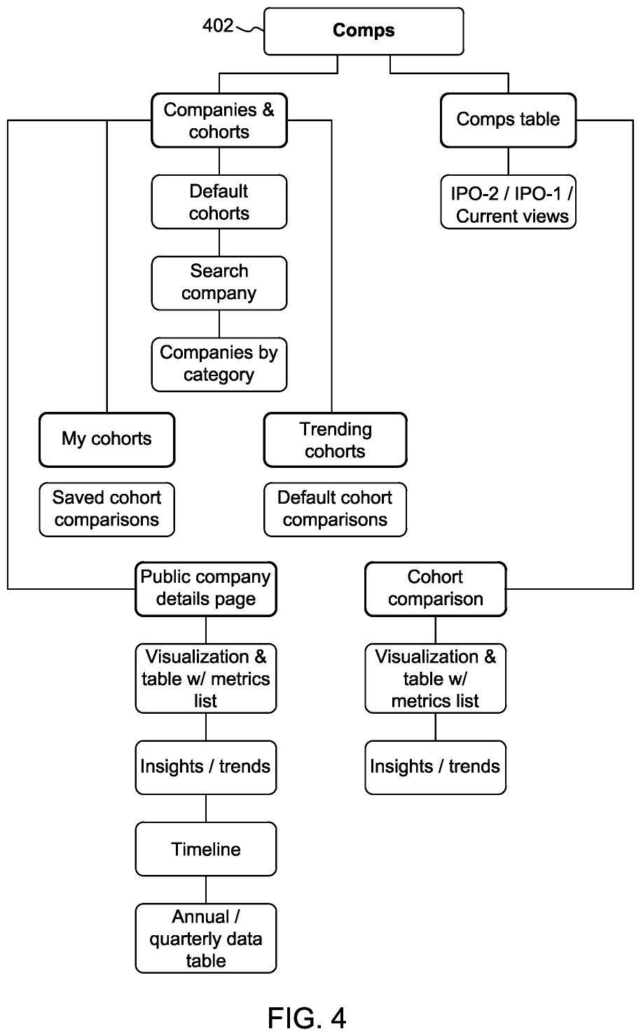

FIG. 4 illustrates a comps module 402, included in the application, to display multiple details related to other companies. For instance, the comps module 402 may display a tab titled ‘Companies and Cohorts,’ which may, on being selected by a BOD member, display additional options such as default cohorts, an option to search a specific company, and/or an option to display several companies by their associated categories. The BOD member may select a desired company and the comps module 402 may accordingly display details associated with the selected company. For instance, the details may include a tabular visualization of a list of metrics associated with the company. The details may additionally include insights, trends, timelines, and annual/quarterly performance of the selected company.

Another option under the ‘Companies and Cohorts’ tab may be ‘My Cohorts,’ which may include a cohort comparison previously saved in a computing device of the BOD member. Yet another option under the ‘Companies and Cohorts’ tab may be ‘trending cohorts,’ which may on being selected, display a list of popular companies with a specific criterion.

The comps module 402 may also include a comps table, which may indicate a comparison of the company with another public company and its performance 1 and 2 years before initial public offering (IPO) of the public company.

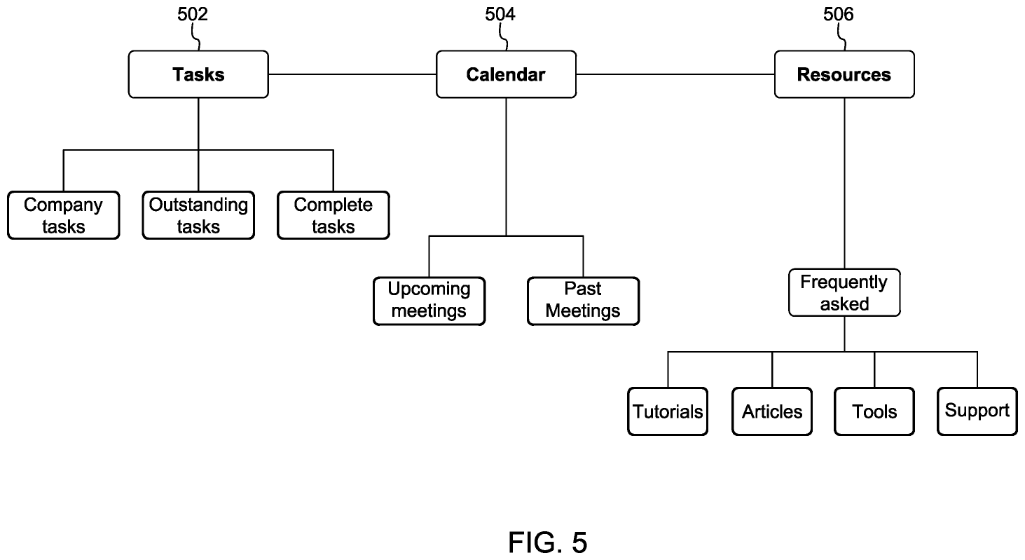

FIG. 5 illustrates additional modules that may be included in the application used by the BOD member, in accordance with the embodiments presented herein. For instance, the application may include a tasks module 502, a calendar module 504, and a resources module 506. The tasks module 502 may include a list of company tasks, a list of outstanding tasks, and a list of completed tasks. Further, the calendar module 504 may include a list of upcoming meetings and a list of past meetings. Further, the resources module 506 may include various resources such as, but not limited to, frequently asked questions or frequently required tutorials, articles, applications, and/or other support materials.

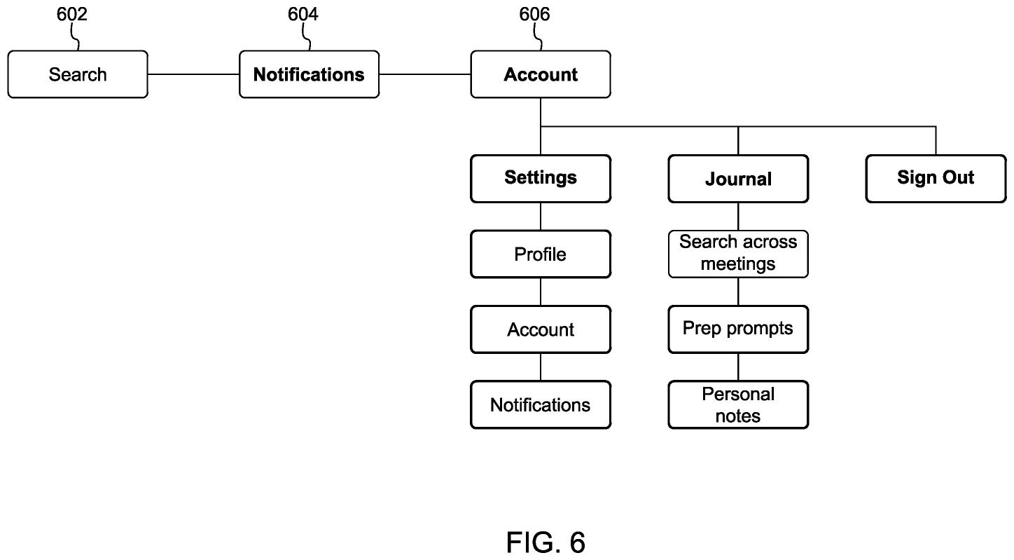

FIG. 6 illustrates various additional modules that may be included in the application, in accordance with the embodiment. For instance, the application may include a search module 602 to allow a BOD member to search for a specific company, setting, or option within the application. The application may additionally include a notifications module 604 to display one or more notifications associate with the BOD meeting. The application may further include an account module 606 that may include a ‘settings’ option to allow the BOD member to view or modify various settings associate with a profile of the BOD member, their account or notifications. The account module 606 may further include a ‘journal’ option that may provide options to the BOD members to search for previous notes across past meetings, provide prompts for preparing notes, or facilitate viewing of stored notes associated with the ongoing BOD meeting. The account module 606 may additionally include a ‘sign out’ option for the BOD member to sign out of the application.

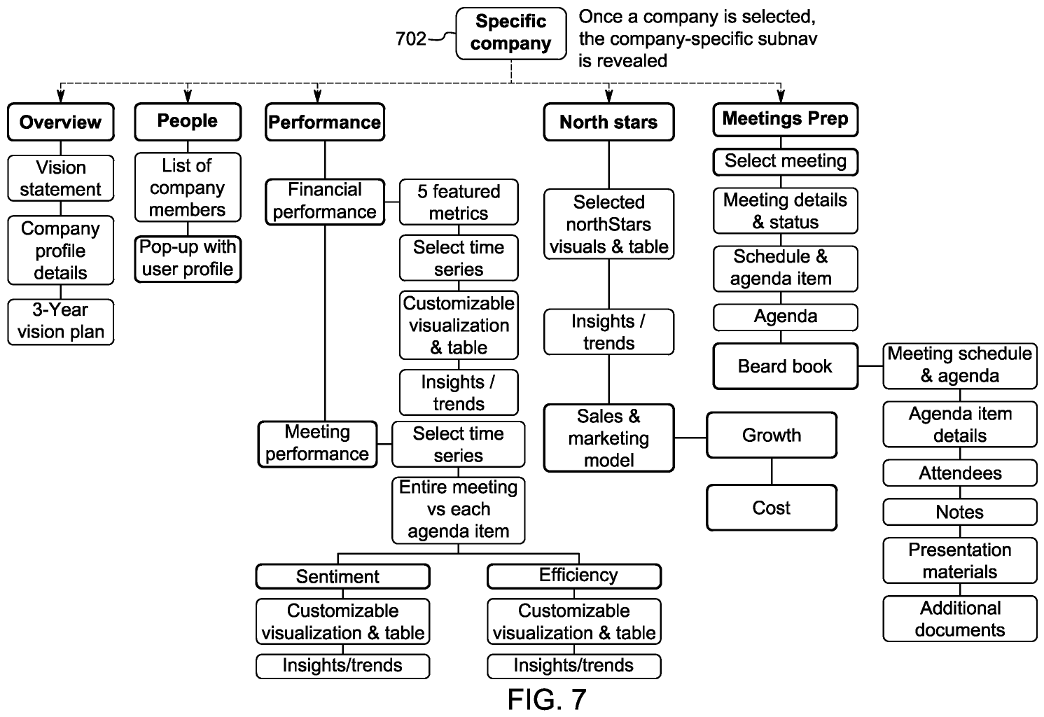

FIG. 7 illustrates another module called specific company module 702, included in the application. The specific company module 702 may, on being selected, provide a drop-down list of stored companies. The BOD member may select any company from the presented drop-down list to view the associated details. For instance, once the BOD member selects a specific company, an ‘overview’ tab may display a vision statement, company profile details, and for instance, but not limited to, a three-year vision plan of the selected company. A ‘people’ tab may display a list of company members and a pop-up associated with additional profile details of each company member.

Further, a ‘performance’ tab may display public data on financial performance of the selected company based on selected metrics, time duration/series and associated trends or insights. The visualization of the financial performance may be customizable. Additionally, the ‘performance’ tab may also display meeting performance associated with the selected company depending on similar criteria as mentioned above. The ‘performance’ tab may also display the sentiment and efficiency of the meetings held by the selected company's executives based on public information accessible by the application. The visualization of presented information related to sentiment and efficiency along with the associated trends or insights, may be customizable by the BOD member depending on design requirements.

The specific company module 702 may additionally include a ‘Northstar’ tab to indicate the Northstar companies and assist the BOD member to view insights or trends related to their performance along with their sales and marketing models. For instance, an insight may include a performance of a Northstar company 2 years before the company's IPO versus the current performance of a company that the BOD member may be evaluating. Another insight may indicate various funding milestones in the past for the Northstar company. These insights may assist the CEO to estimate growth of their company in comparison to the Northstar company.

The specific company module 702 may additionally include a ‘meeting preparation’ tab. This tab may assist the BOD member to select a previous meeting of a company they may be associated with. The BOD member may access the meeting details along with the schedule and agenda items associated with the selected meeting. The BOD member may also view attendees, notes, presentation materials, and/or any additional documents associated with the previous meeting to prepare for an upcoming meeting. The ‘meeting preparation’ tab may also include options to create a new meeting, set agenda items for the created meeting, schedule invite attendees, and edit a calendar associated with a meeting. This tab may also display a T minus calendar that may display a number of days till the upcoming meeting.

Further, the company module 702 may assist the BOD member to select a previous meeting and access the meeting details along with the schedule and agenda items associated with the selected meeting. The BOD member may also view attendees, notes, presentation materials, and/or any additional documents associated with the meeting.

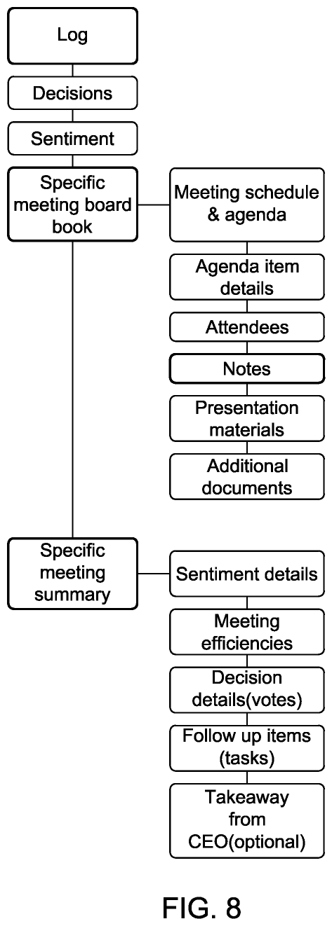

The BOD member may also access a logbook associated with a BOD meeting held by the selected company in a ‘log’ tab, as illustrated in FIG. 8. For instance, the BOD member may access the decisions taken in the BOD meeting and sentiment associated with the BOD meeting. Additionally, the BOD member may be able to access a meeting summary on any specific aspects of the meeting as well. For instance, the sentiment details, meeting efficiencies, decision details (e.g. votes), follow-up tasks, and takeaway from the CEO may be accessible to the BOD member.

FIG. 9 illustrates a sign-up process 900 for a CEO of a company or an internal stakeholder of the company. The sign-up process 900 may include all the steps as illustrated in FIGS. 2A-2B. Additionally, FIG. 9 may also include a step 902, in which the CEO may create a company profile to capture BOD meeting or company details in accordance with the embodiments presented herein. The CEO may additionally invite team members to the created company profile and the invited team members may accordingly sign-up using the sign-up process 900 illustrated in FIGS. 2A-2B.

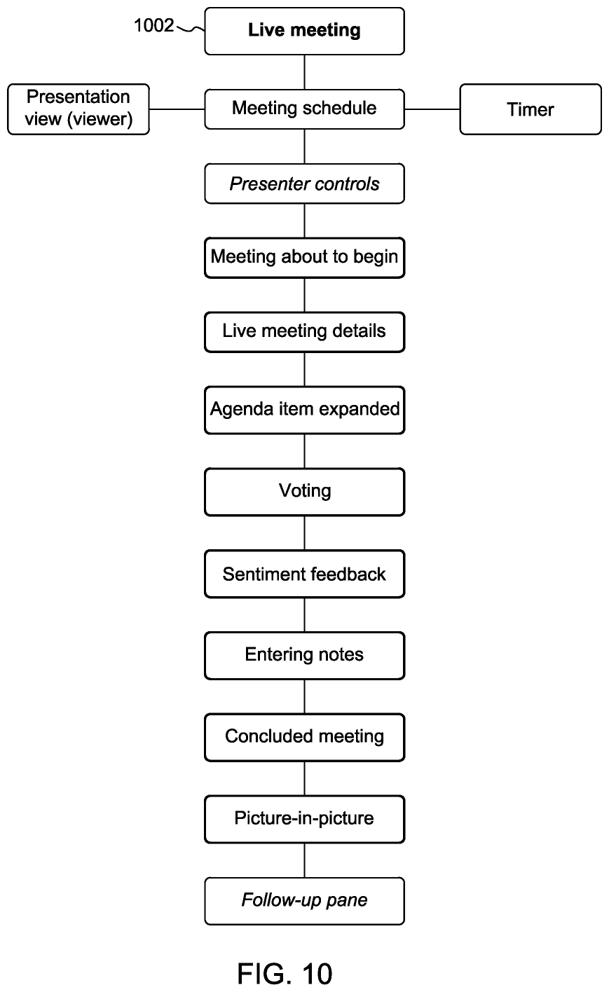

FIG. 10 illustrates a live meeting module 1002 that is included in the application, to display various visuals to a CEO or an internal stakeholder during a BOD meeting. The live meeting module 1002 may include all the components of the live meeting module 202, as illustrated in FIG. 2A-2B. However, the live meeting module 1002 may additionally include presenter controls for the CEO or the internal stakeholder, depending on the presenter, as applicable. The live meeting module 1002 may additionally include a follow-up pane, in which a presenter may keep including agenda items during the meeting, for following up of them later.

Further, the information architecture, when used by the CEO or an internal stakeholder may also include a comps module similar to the comps module 402, as described earlier.

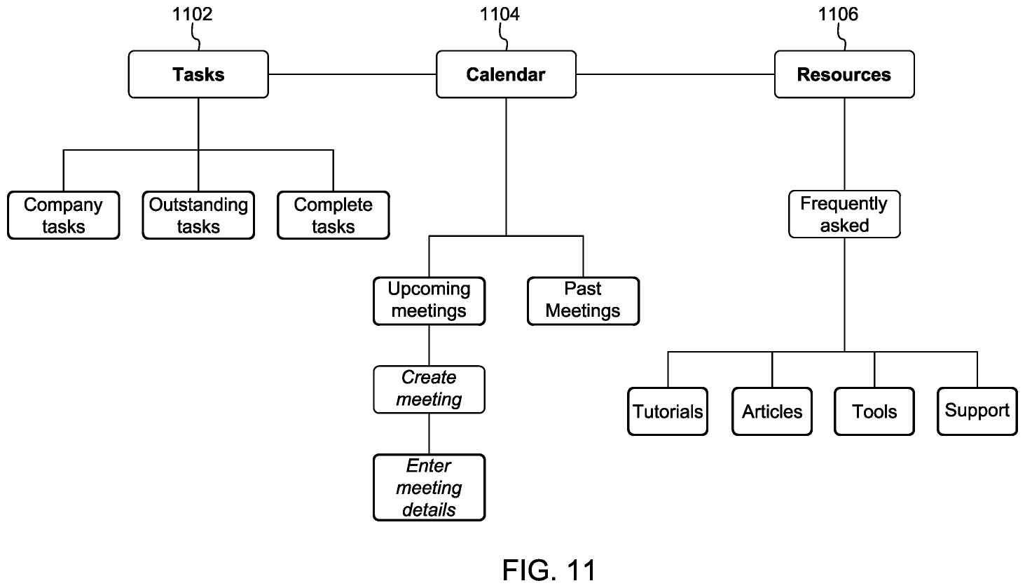

Further, the information architecture for the CEO or internal stakeholder may also include a task module 1102, a calendar module 1104, and a resource module 1106, as illustrated in FIG. 11. These modules may be similar to the corresponding modules described earlier in the context of FIG. 5. In an embodiment, the calendar module 1104 for the CEO/internal stakeholder may additionally include an option to create a meeting and/or an option to enter meeting details, as illustrated in FIG. 11.

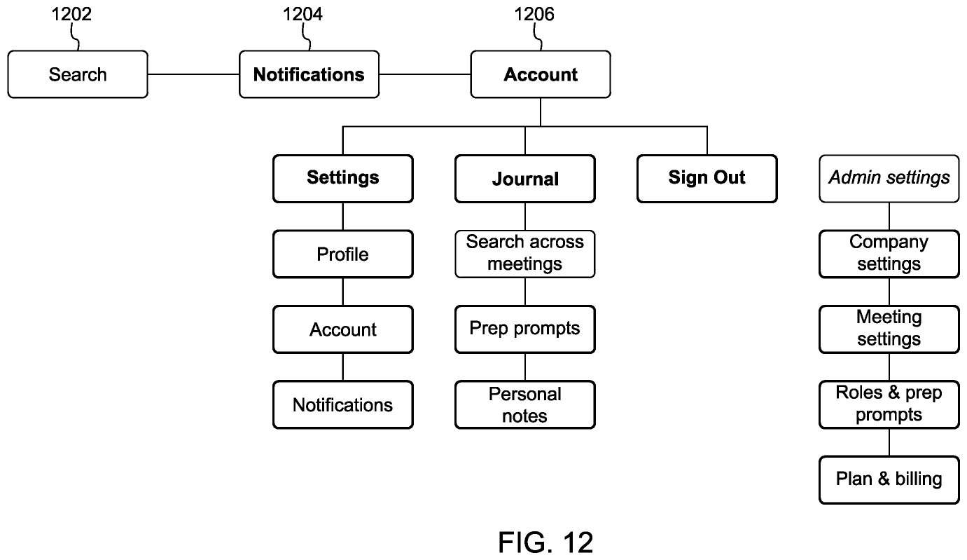

Further, the information architecture for the CEO or internal stakeholder may also include a search module 1202, a notifications module 1204, and an account module 1206 similar to the corresponding modules described earlier in the context of FIG. 6. In an embodiment, the account module 1206 may additionally include an option to configure admin settings, as illustrated in FIG. 12. This option may include company settings, meeting settings, roles and preparation prompts, and planning and billing options.

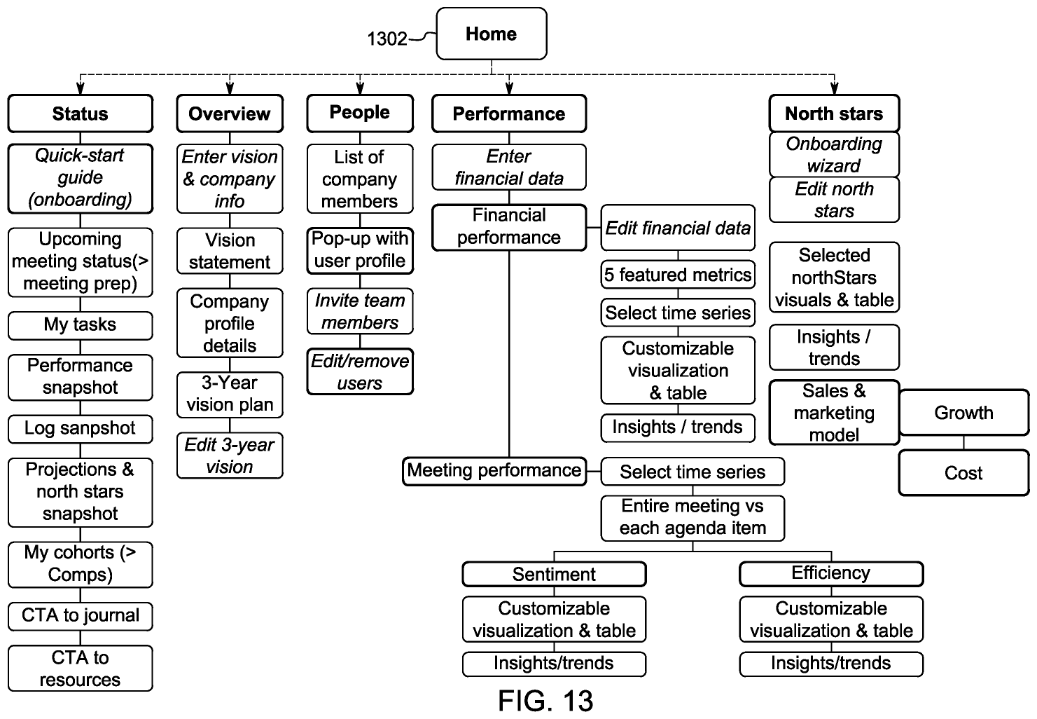

Further, the information architecture for the CEO or internal stakeholder may also include a home module 1302. In an embodiment, the home module 1312 may additionally include a ‘status’ tab, which may include various options, as illustrated in FIG. 13. For instance, this tab may include an upcoming BOD meeting status, pending tasks associated with the BOD meeting, performance snapshot of the CEO's company, a log snapshot to display details of a previous meeting, a CTA to journal, a CTA to resources, financial projections, cohorts, and comparison with Northstar companies.

Further, the home module 1302 may also include an ‘overview’ tab, which may include various options, as described in the context of FIG. 7 earlier and as illustrated in FIG. 13. The overview tab may further include additional options for the CEO or internal stakeholder to add company and vision information and edit the three-year vision of the company. Further, the ‘people’ tab may be similar to the corresponding tab described in the context of FIG. 7 but may additionally include options to invite team members and/or to edit and remove team members.

The ‘performance’ tab, as illustrated in FIG. 13 may include all options, as described in the context of FIG. 7 and may additionally include an option to enter and/or edit financial data. Further, a ‘NorthStar’ tab may include data about Northstar companies, as described in the context of FIG. 7 earlier. The ‘NorthStar’ tab may additionally include an onboarding wizard option to add a Northstar company and an option to edit/remove any stored Northstar companies.

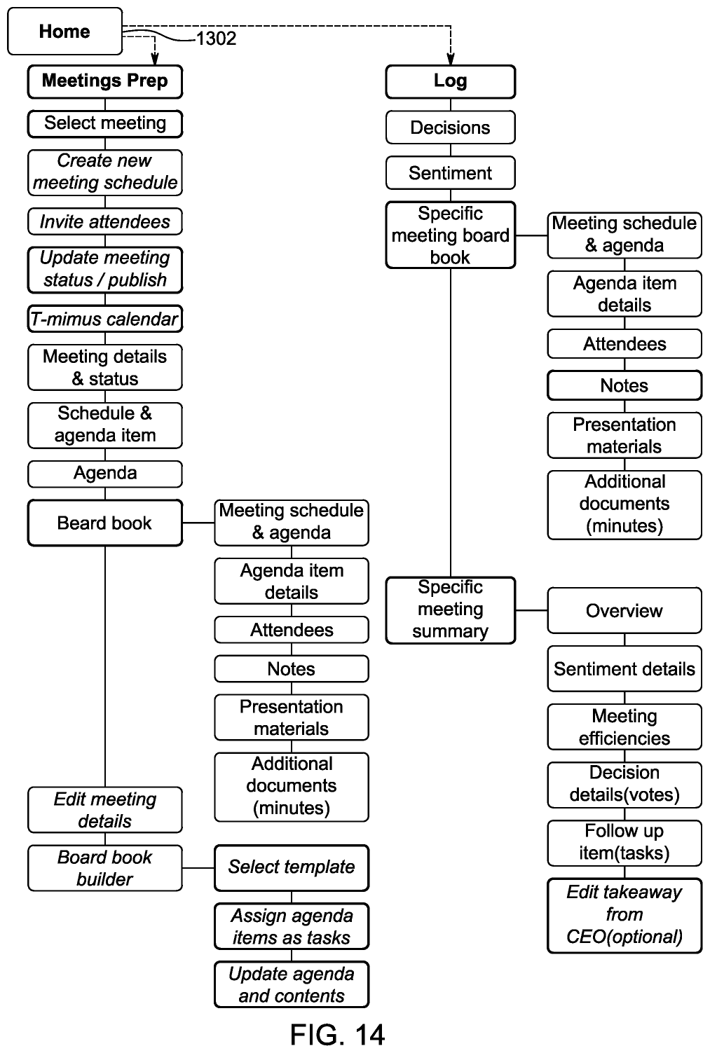

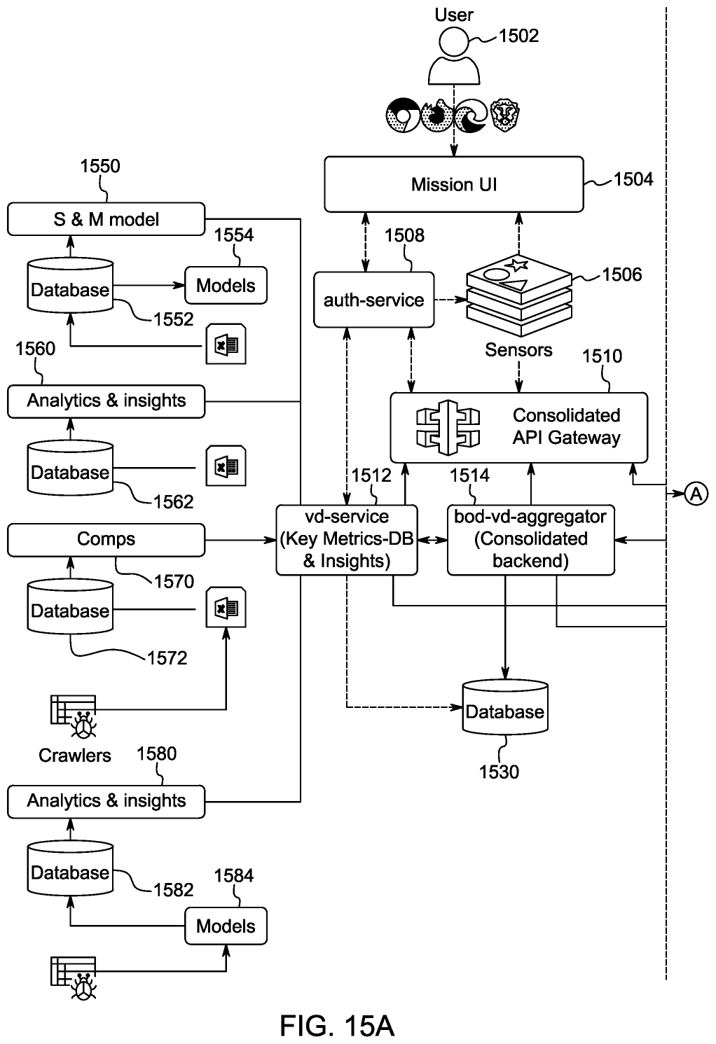

The home module 1302 may additionally include a ‘meeting preparation’ tab, as illustrated in FIG. 14. This tab may assist the CEO or internal stakeholder to select a previous meeting and access the meeting details along with the schedule and agenda items associated with the selected meeting. The CEO or the internal stakeholder may also view attendees, notes, presentation materials, and/or any additional documents associated with the previous meeting to prepare for an upcoming meeting. The ‘meeting preparation’ tab may also include options to create a new meeting, set agenda items for the created meeting, schedule invite attendees, and edit a calendar associated with a meeting. This tab may also display a T minus calendar that may display a number of days till the upcoming meeting. This tab may additionally include a board-book builder that may include options to assign agenda items to employees with or without using a template as well as options to update the agenda items.

The home module 1302 may also include a ‘log’ tab that includes several details associated with all previous meetings held by the company, as illustrated in FIG. 14. For instance, the CEO may access the decisions taken in a previous BOD meeting, a summary of the BOD meeting, and a sentiment associated with the BOD meeting. Additionally, the CEO may be able to access a meeting summary on more specific aspects of the meeting as well. For instance, the sentiment details, meeting efficiencies, insights, decision details (e.g. votes), follow-up tasks, and takeaway from another CEO may also be accessible.

### 5. System Architecture

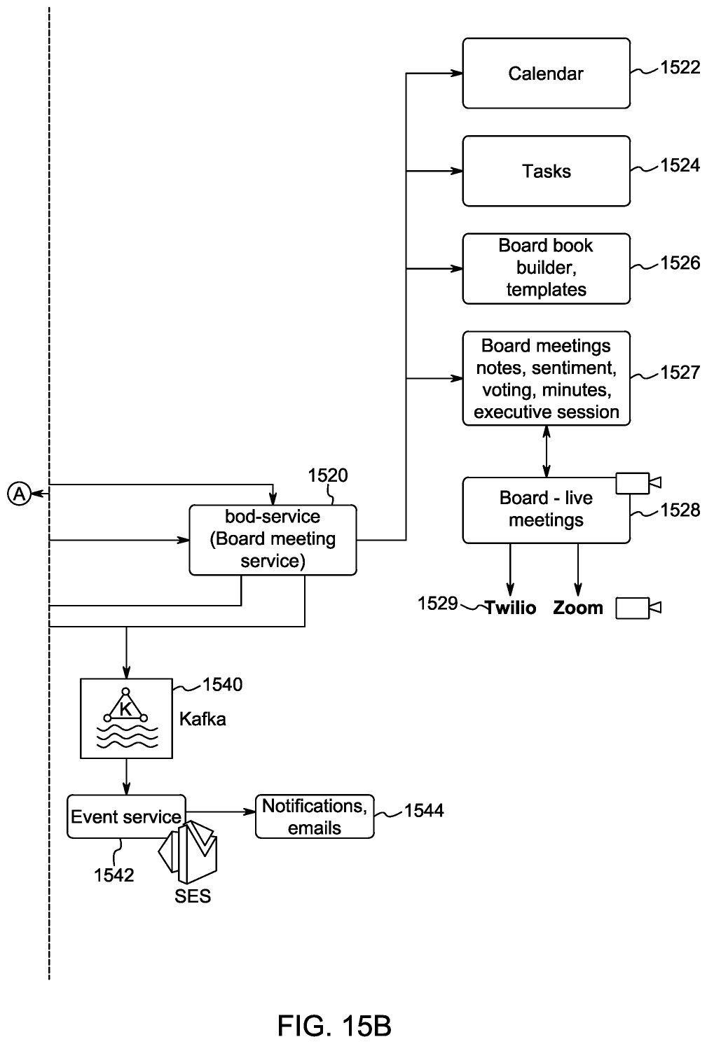

FIG. 15 shows a system architecture that drives the invention described herein. Tracing the system from the user 1502, the user 1502 interacts with the user interface 1504 or presentation layer via a browser. Each user session 1506 may be authenticated 1508 with credentials and access information stored in a permissions database 1530. Once authenticated with permissions established, the user 1502 can access services 1512, 1514, 1520 via an API gateway 1510.

The key metrics database and insights service 1512 may include an S&M Model 1550 that includes models 1554 that access information in a database 1552 that may be fed by an excel sheet. The models may include a sequence of IF/THEN statements built on a database of business assumptions entered about the company. An example IF/THEN statement may be “If we add______% to our sales budget, we can expect______% sales growth.” There may be hundreds of these statements based on established business logic and these models will be helpful to users as they make business decisions.

The financial performance insights 1560 also include a database fed by an Excel sheet and may include company data and graphs based on company performance. Again, this information helps users understand the company's position at any time.

The comps metric 1570 similarly fed by a database 1572 of public company EDGAR data fed by crawlers allows a user to review metrics of other companies that may be desirable to compare as Northstars.

And finally the analytics and insights insight 1580 fed by a database and models 1584 compares the subject company to Northstar companies using data from the comps database 1572 using a variety of selectable metrics.

The board of directors service 1520 includes services for calendaring 1522, tasks 1524, the board book builder and templates 1526, board meetings organization 1527, and conducting board meetings 1528 using other services 1529 within the system.

The aggregator connects to the key metrics 1512 and bod service 1520 as well as the permissions database 1530, but also generates events via a service like Kafka 1540 to an event service 1542 to generate emails and other notifications 1544.

### 6. Example

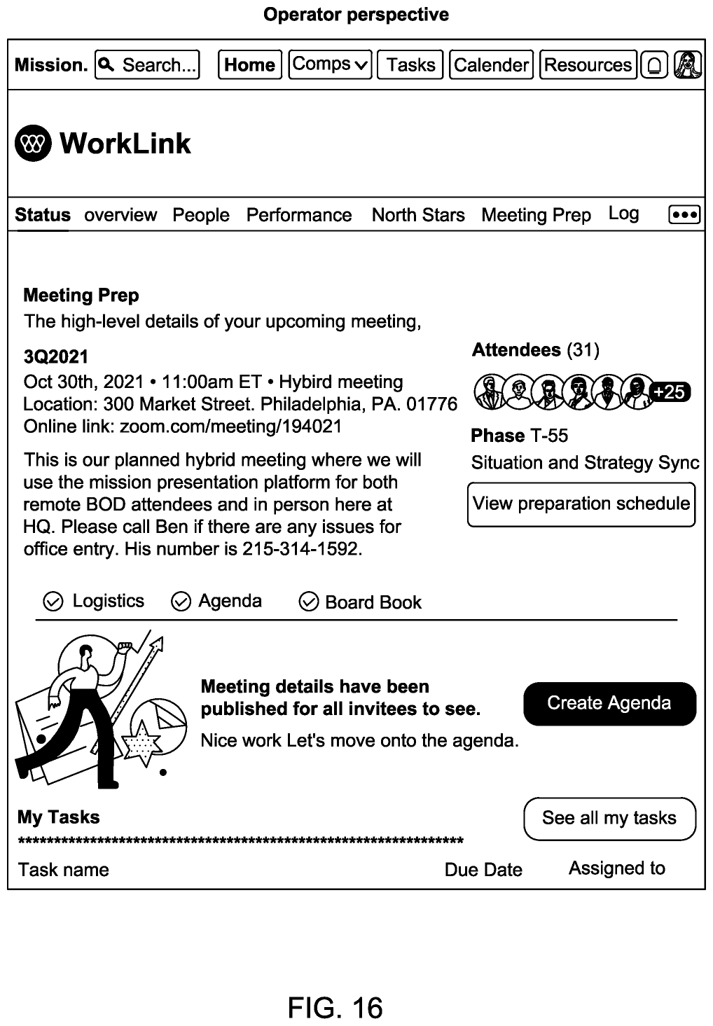

FIGS. 16-69 show a screenshots accompanying a below Demo Script.

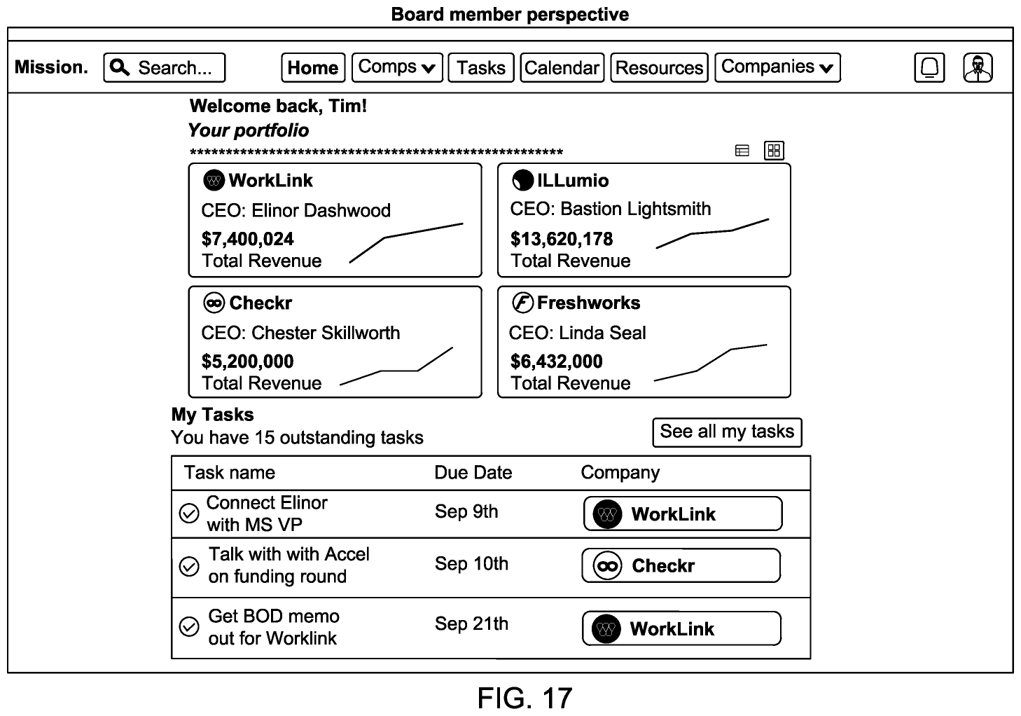

FIGS. 16 AND 17

FIGS. 16 and 17 show related operator and board member perspectives respectively.

This is a product specifically designed for private, venture backed CEOs and Board members who are scaling from seed stage to pre IPO stage. Mission is a system based on experienced operators and investors in venture capital and private equity. There are two perspectives of the platform, which are connected together with a long term strategic decision-making framework.”

The system is tailored both to Founders and CEOs who desire greater alignment, consistency and strategic contributions among all Board members and Board members who EAGER to provide THOSE strategic insights and operational support to the CEO and management team.

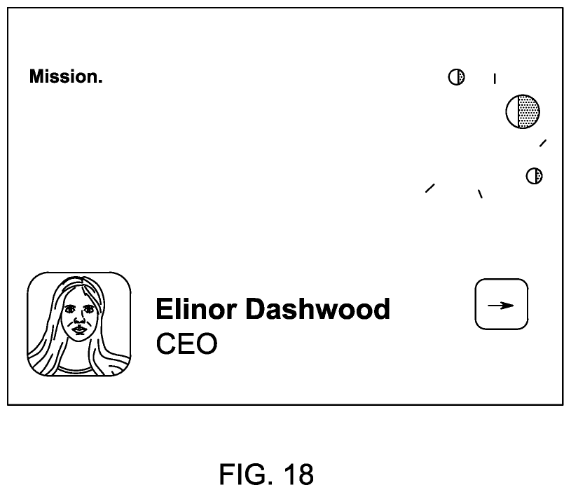

Here is a select set of features and workflows of the Mission system.
Meeting Management
   People
   Meeting Prep
   Board Book Viewer
   Board Book Builder
   Live Meeting
   Sentiment Rating
Tools
   Portfolio tracking
   Three-Year Vision Framework
   Tasks
   Journal
   Prep Prompts
   Resources
   Calendar
Results
   Executive Session
   Meeting Summary
   Log
   Financial Performance
   Meeting Performance
Marketplace Benchmarks
   Comps Companies Database
   Cohort Creation
   Comps Table
   North Stars
   FIG. 18

Now to see Mission in action . . . Meet our customer WorkLink. WorkLink is a platform for both employees and management. It delivers a secure personalized IT tool kit for every employee across every work channel. Second, WorkLink gives management an AI based engagement engine to maximize productivity for the company.

Let's see first hand what the Mission platform can do. First we'll follow Elinor, CEO of Worklink.

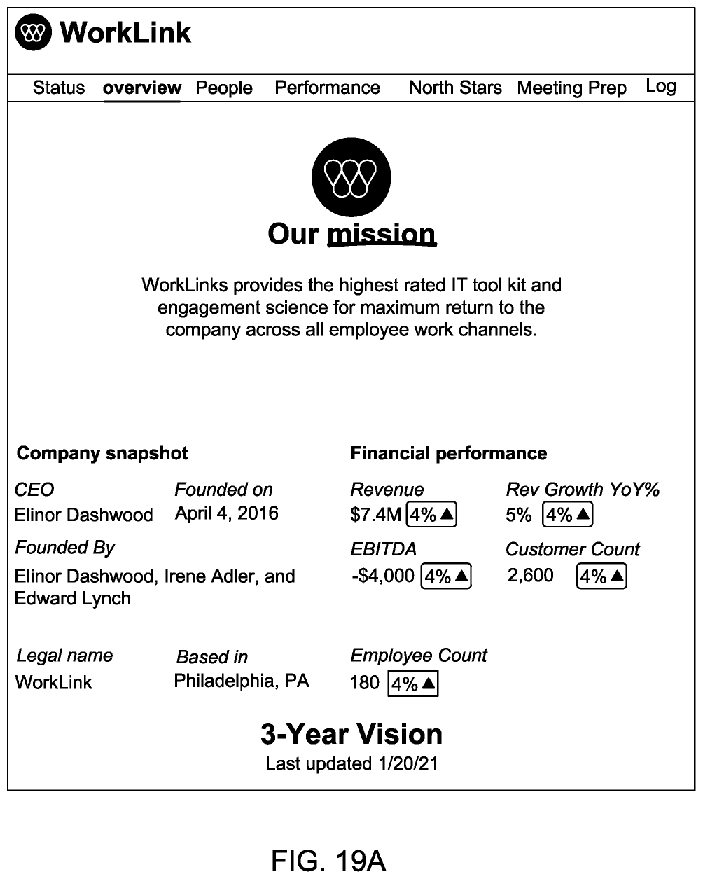

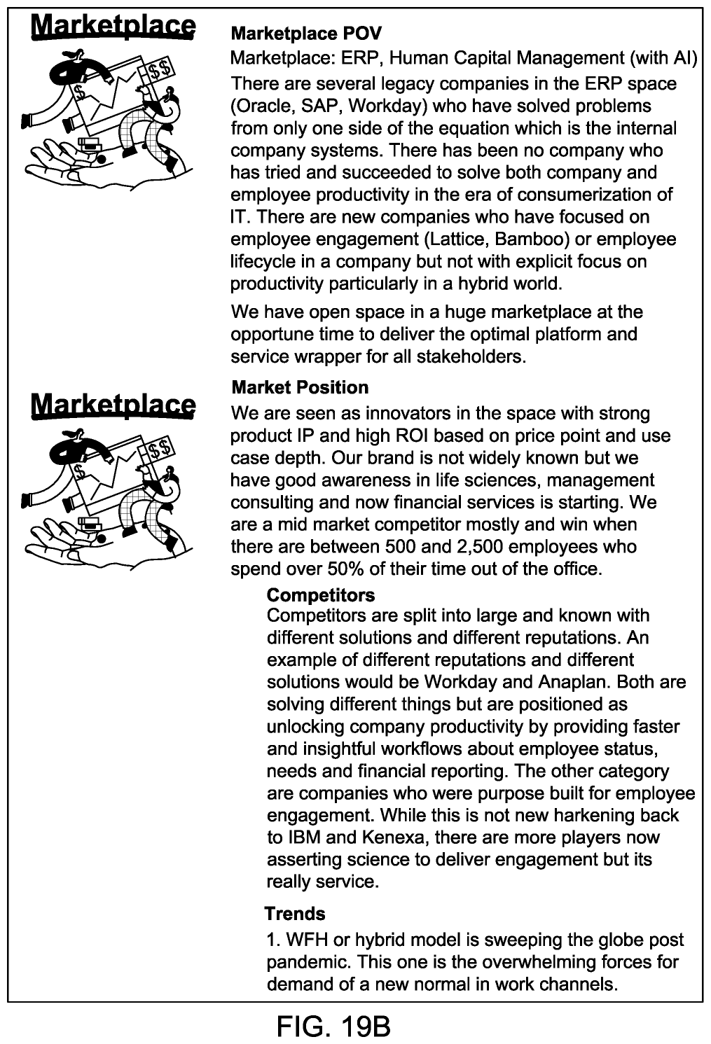

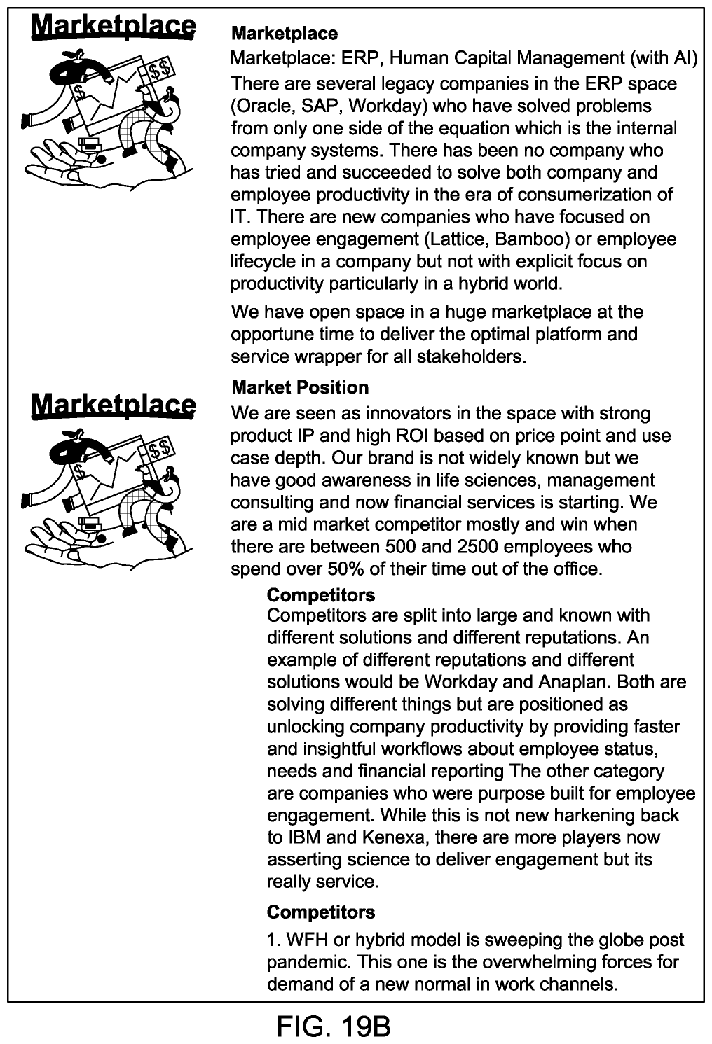

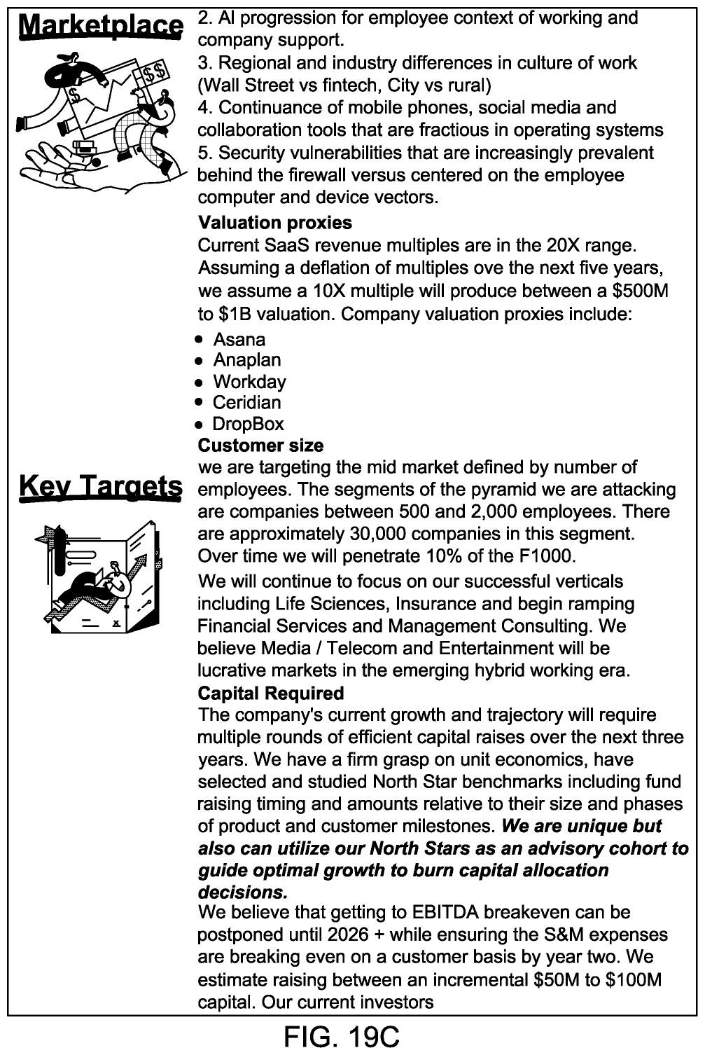

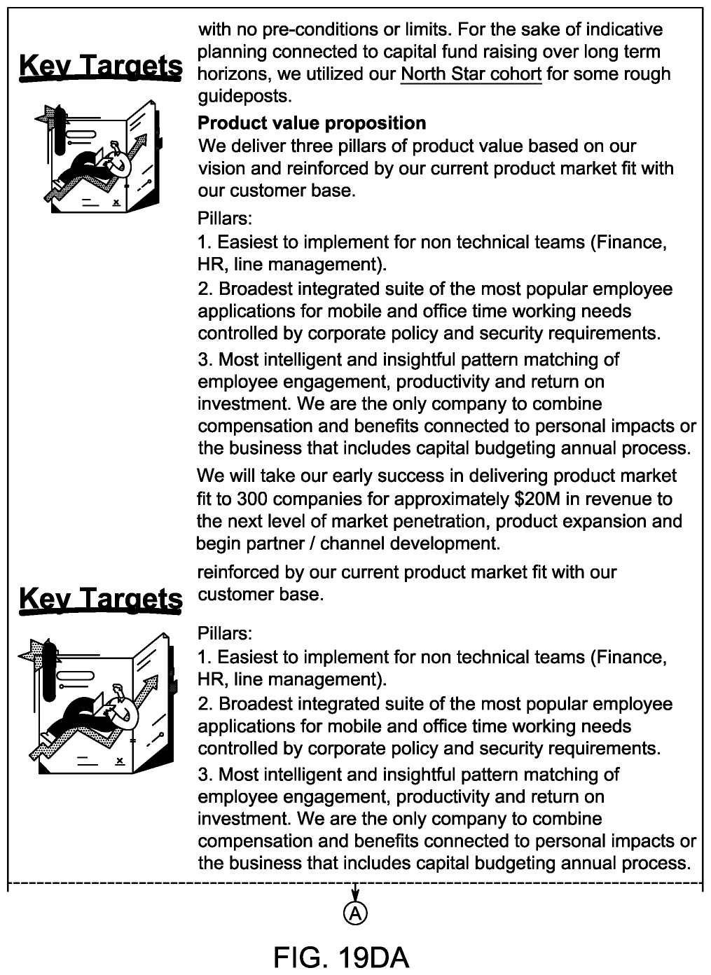

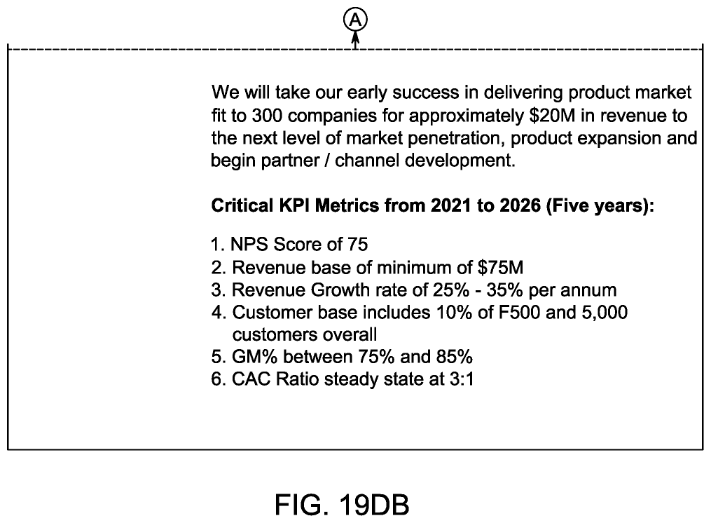

FIGS. 19A-19DA and 19DB

FIGS. 19A-19DA and 19DB show an overview, reviews company overview, including Three Year Vision.

As part of her set up process with Mission, Elinor laid out a comprehensive Three Year Vision based on the Mission-provided framework, which addresses Marketplace landscape and key internal drivers. This provides the board continuity between long term WorkLink objectives and the current operating cycle.

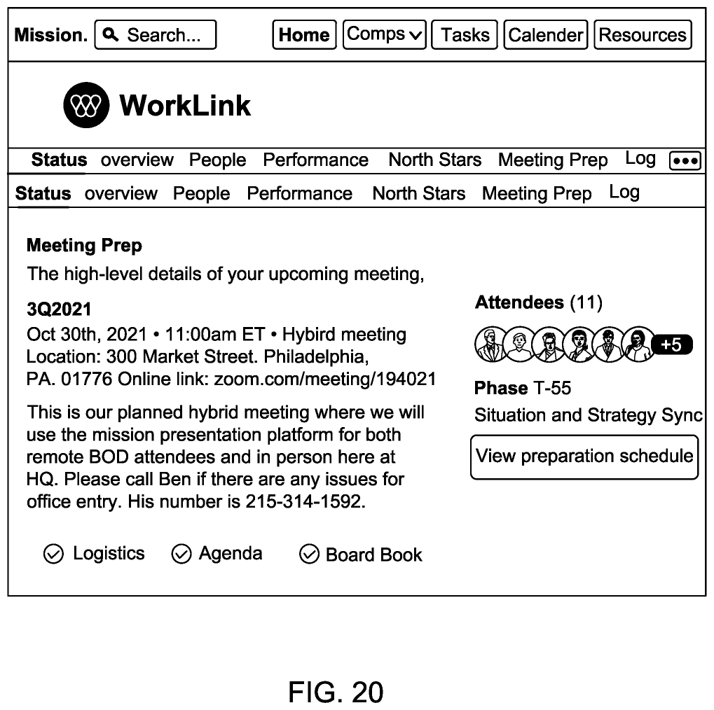

FIGS. 20-24

FIG. 20 shows a Homepage Status dashboard, modules, checking Meeting Prep, Tasks, Performance, Log, Projections.

After taking a look at her Three-Year vision Framework, Elinor goes to her Status homepage for her company, Worklink. This status page shows her everything in the platform at a snapshot view.

Right at the top, in the Meeting Prep section, she sees that It's T-55; Worklink is about two months out from their Q3 2021 quarterly board meeting.

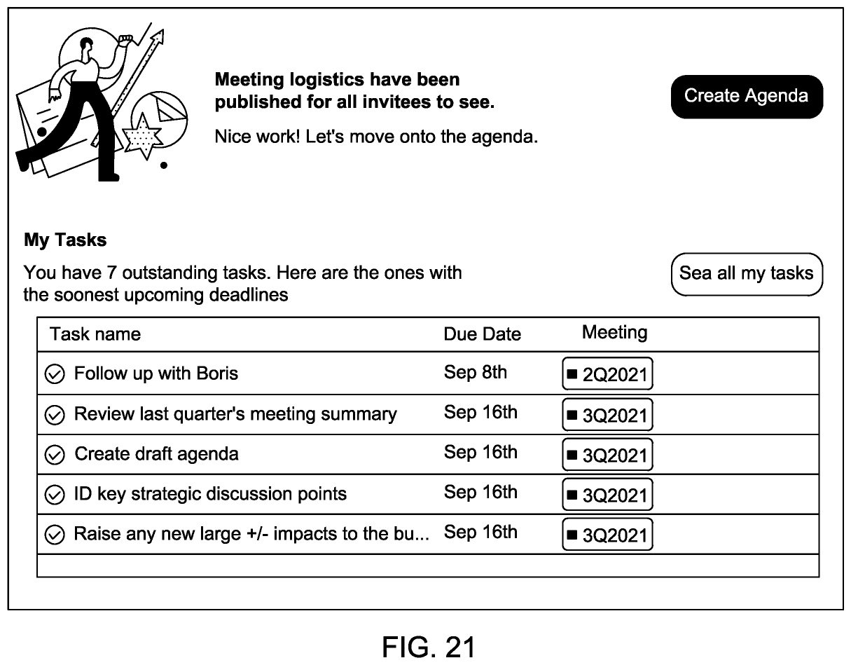

FIG. 21 shows the My Tasks screen. Right, she thinks, I should give a call to the Chair to check in and see if anything new from him or other members. Scrolling down, she sees her upcoming Tasks, and is reminded right there of her quarterly tasks for this phase of the meeting.

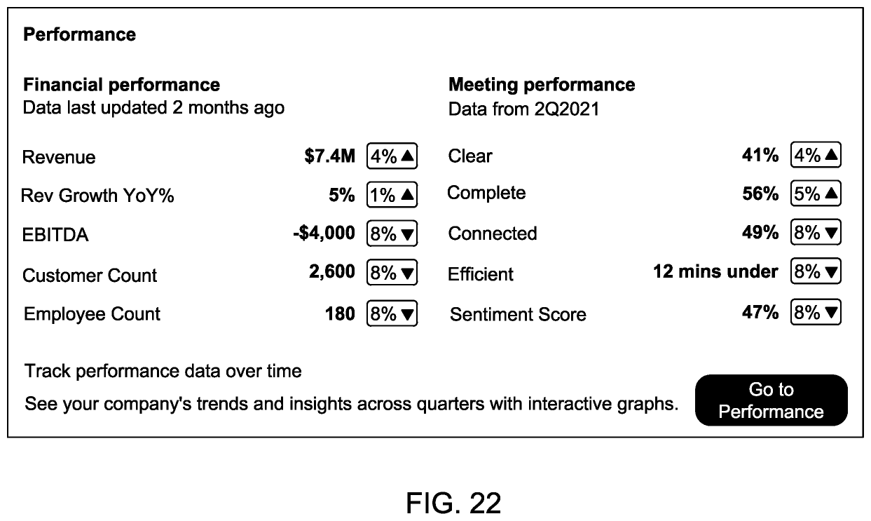

FIG. 22 shows Performance. She can see at a glance the current Performance metrics from the latest quarter for her company's financials, and her last board meeting as rated by the board.

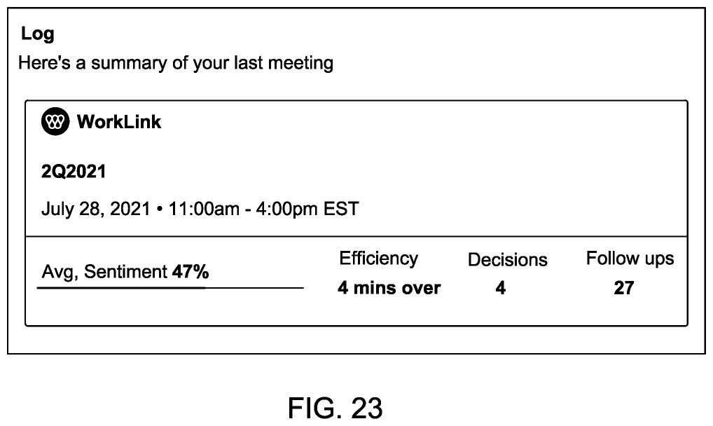

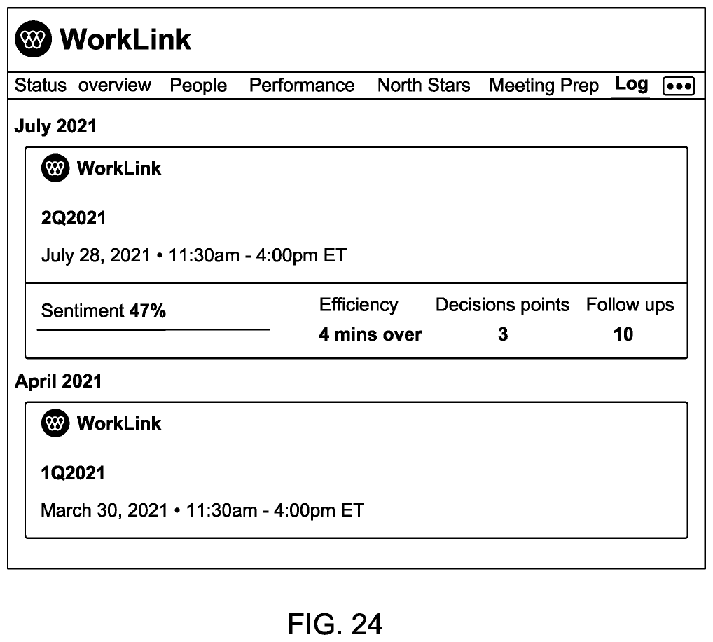

FIGS. 23 and 24 show the Log. The Log section gives her quick access to the last meeting, for when she wants to review the board book package or the meeting summary she distributed after the meeting.

The top level navigation will give her access to the Comps section, her Tasks, her Calendar, the Resources section, as well as her personal profile and notifications. Here she sees a notification reminder that her Monthly Board Call is coming up in 3 days.

Elinor knows her team is all set for the monthly board call. For her quarterly, meeting, however, she knows within about a week, she should draft a BOD agenda for review with her BOD Chair and then begin to assign tasks for creating the board book. But first she wants to review last quarter's meeting summary for continuity with the upcoming meeting.

Now, in the Log section of her company's Mission workspace, where all past meeting content lives, she goes to the most recent meeting and clicks Summary.

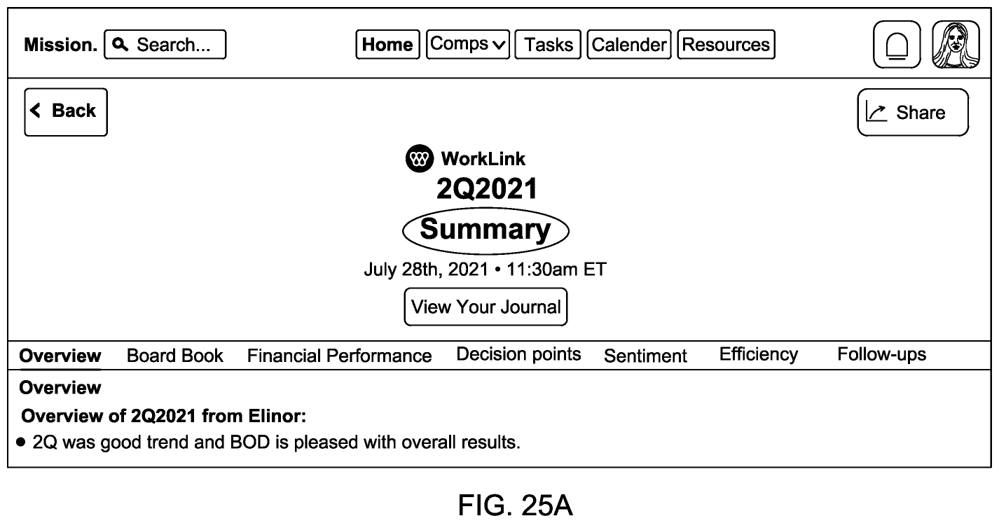

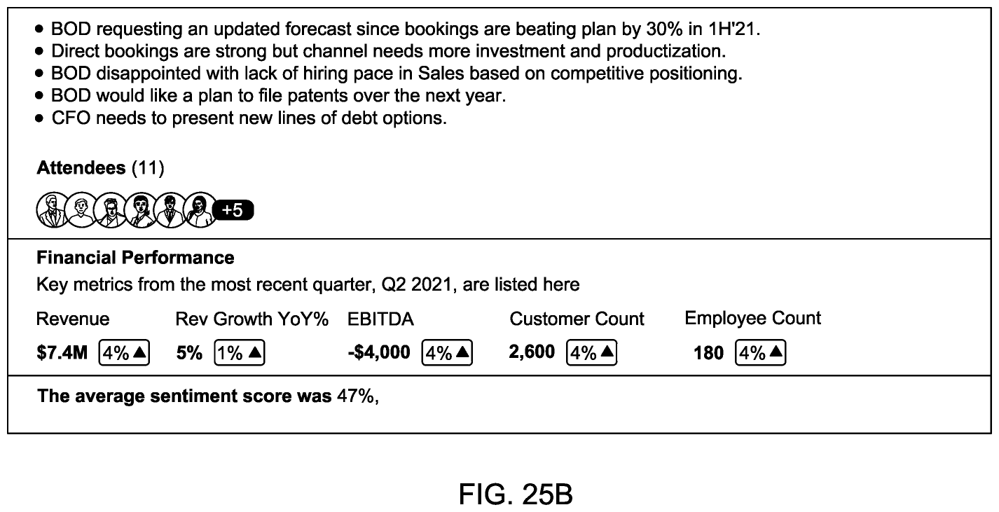

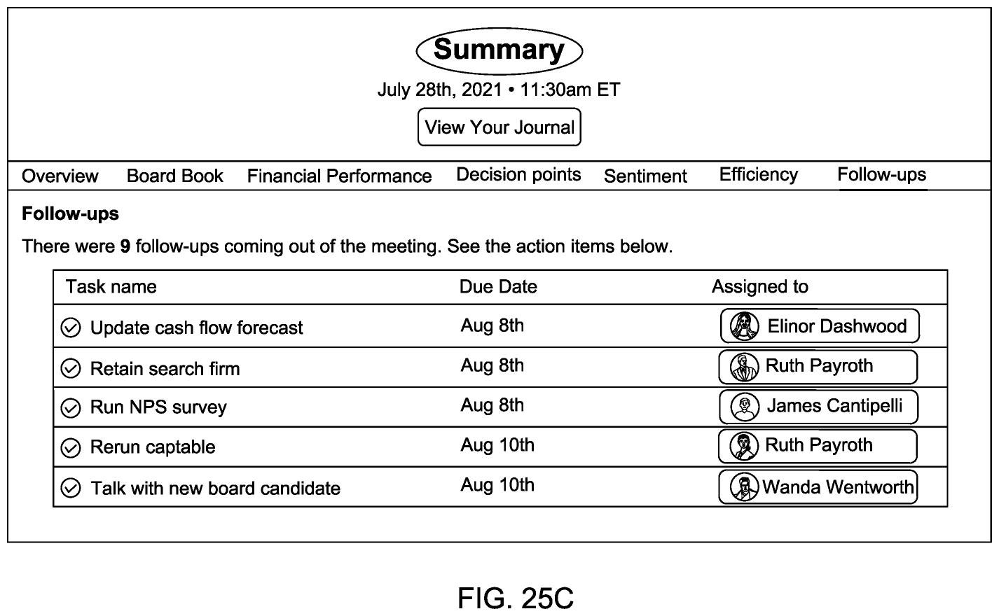

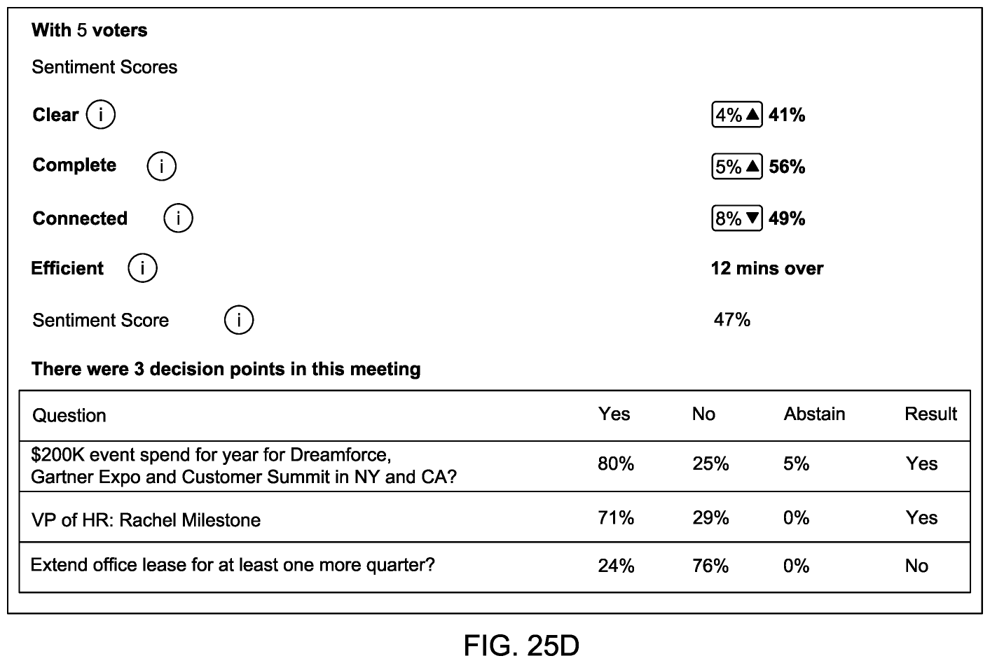

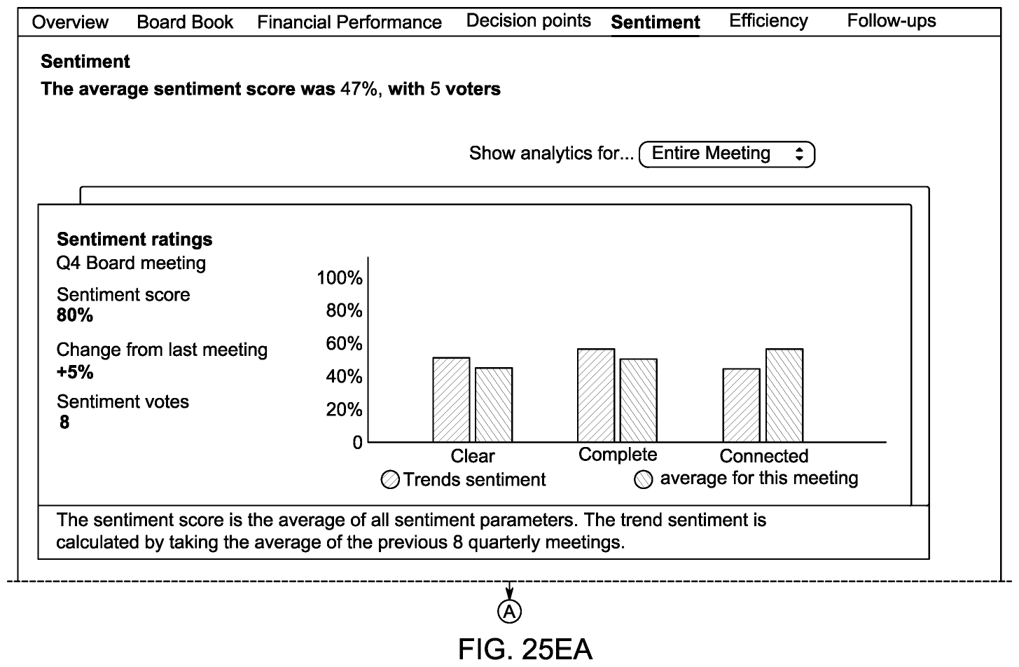

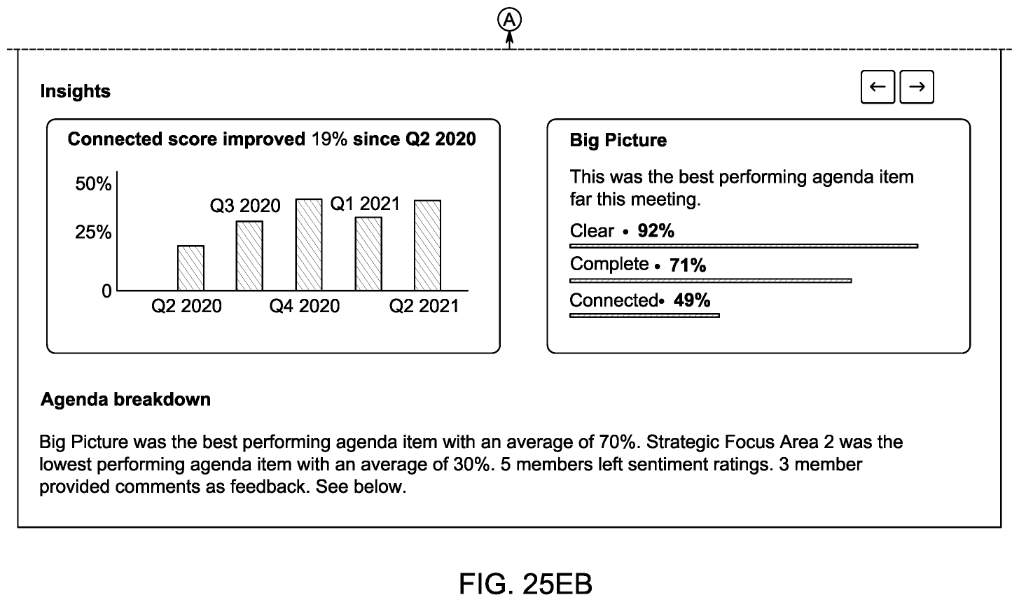

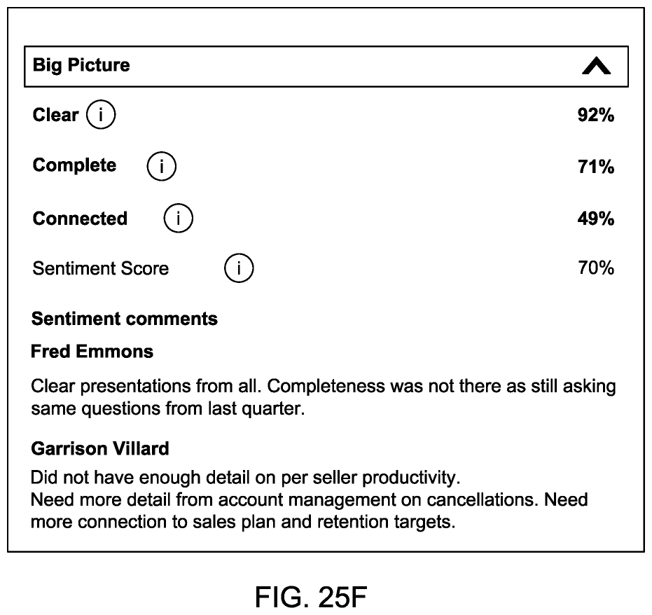

FIGS. 25A-F

FIGS. 25A-F show an automated executive session summary like this is created after every meeting, neatly housing all the information on how the meeting went, including a snapshot of the company performance, the sentiment ratings, and the decision points.

First, Elinor clicks on the Follow-ups tab, to double check that all the action items from the meeting last month are completed. Great, all these tasks are marked as complete. Then, she wants to dive into the sentiment ratings so she clicks “Sentiment.”

In FIG. 25E, she sees an overview of the sentiment rating, showing how the meeting performed in the 3 sentiment parameters: Clear, Connected, and Complete. Intelligent insights tell her what the best performing agenda item was, how the meeting compared to the average, and more.

In FIG. 25F, getting a bit more detailed, she checks out the ratings for the first agenda item which she presented, Big Picture, and reads some of the Board feedback.

After her refresher, she's ready to officially begin her next meeting agenda.

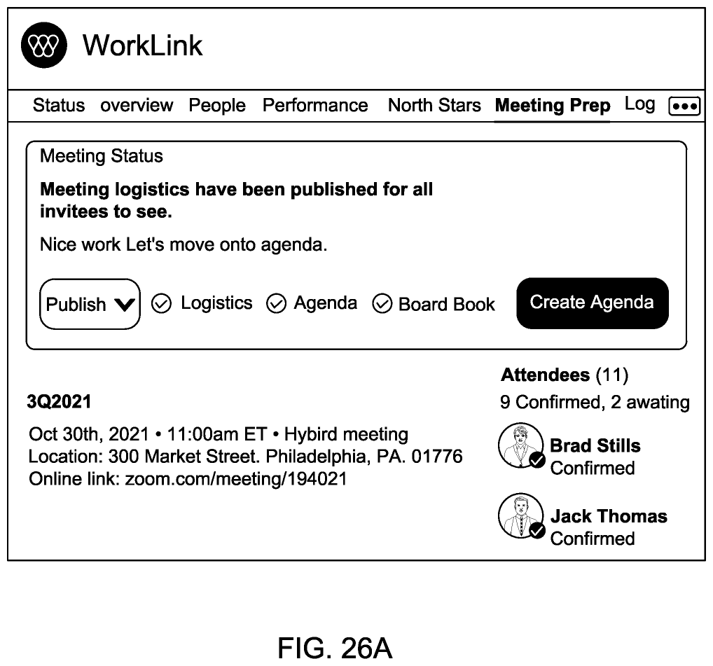

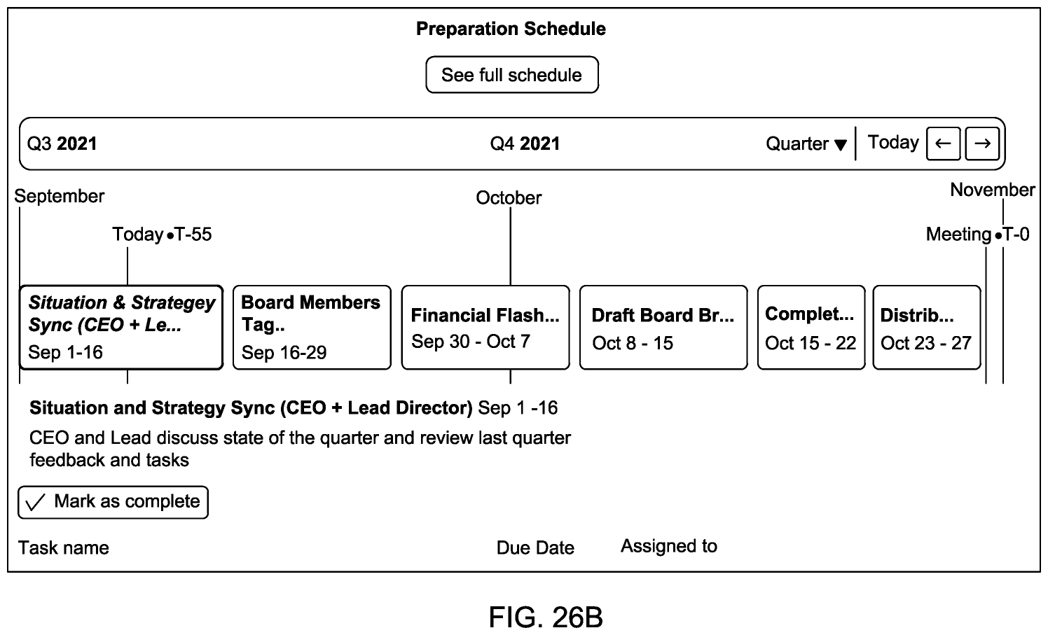

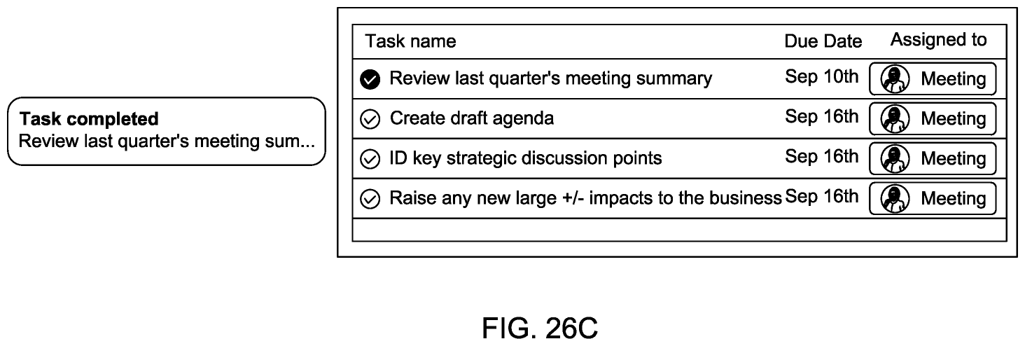

FIGS. 26A-C

FIGS. 26A26C show meeting prep, check publish status, details published, Agenda and Board Book not published, check/interact with preparation schedule, and check off task as complete.

In FIG. 26A, on the Meeting Prep page for her Q3 meeting, Elinor can publish materials as they are ready, and see an expanded view of the preparation schedule from her Homepage.

In FIG. 26B, mission includes an intelligent calendar tool that syncs to the board meeting date and automatically provides a preparation timeline for CEO and management team.

In FIG. 26C, she marks a task as complete right here in the preparation schedule, and sees her next task is beginning the Agenda.

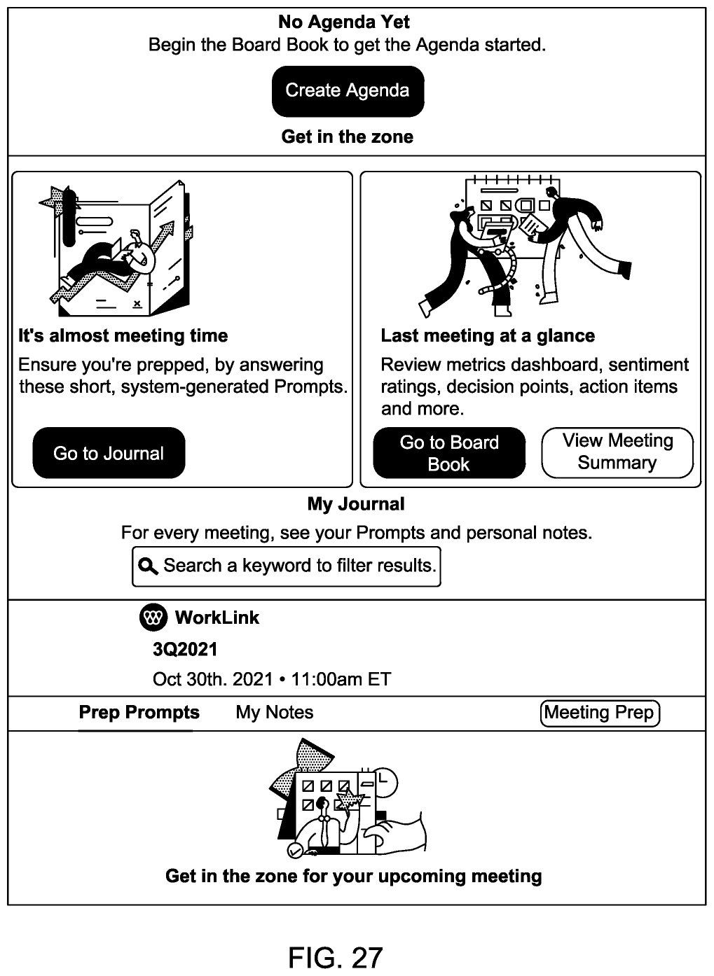

FIG. 27

FIG. 27 shows Meeting Prep, Go to Journal. Before she creates the agenda, she wants to complete her Prep Prompts for the upcoming meeting. Meeting Prep has a quick link to her Journal, which houses all her personal notes for upcoming and past meetings.

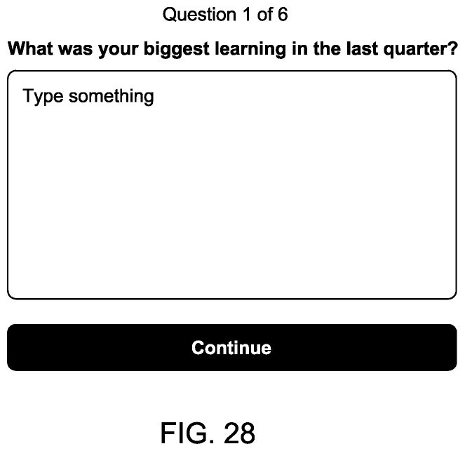

FIG. 28

FIG. 28 shows Journal, Click “Complete Preparation Survey,” Complete Preparation Survey questions, Review Preparation Survey answers, Click “Meeting Prep.”

In the Journal, she begins her system-generated Prep Prompts for this meeting. The platform includes these customizable quarterly prep prompt templates for every stakeholder, to ensure everyone comes as prepared as possible. For Elinor, it helps her think critically about her company and her board and get in the right mindset before initiating a new meeting's agenda.

Elinor answers thought-provoking questions, such as about her biggest learning last quarter, any major competitor news, and whether her requests for support from the last meeting was done.

After reviewing last quarter's financial dashboard, sentiment results, north stars progression, and completing the Prep Prompts, she feels prepared to go back and create her agenda for this meeting.

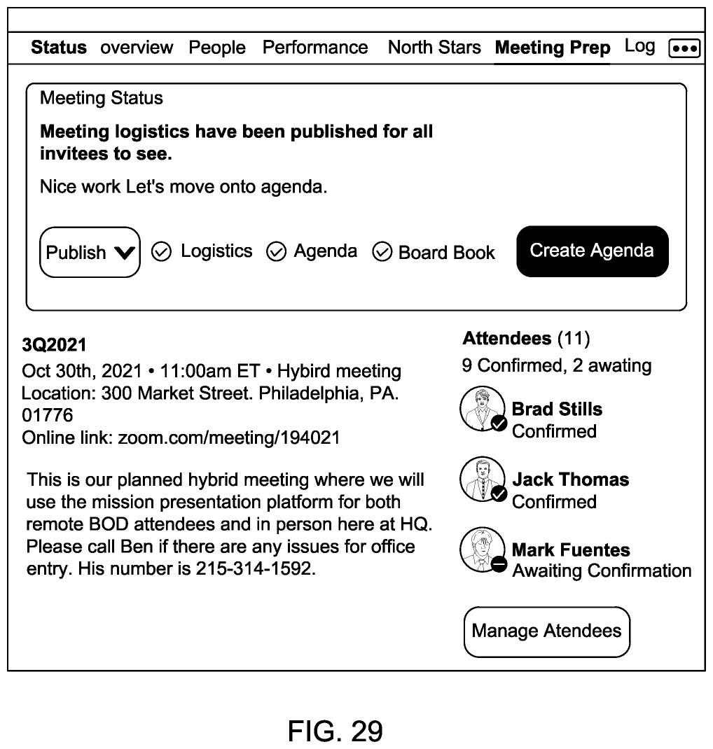

FIG. 29

FIG. 29 shows Meeting Prep, Click Create Agenda, where Back on Meeting Prep, Elinor clicks “Create Agenda” to get started.

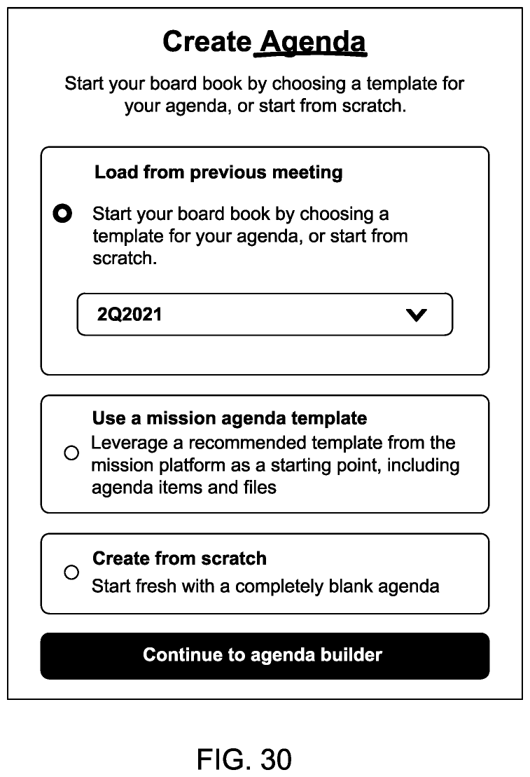

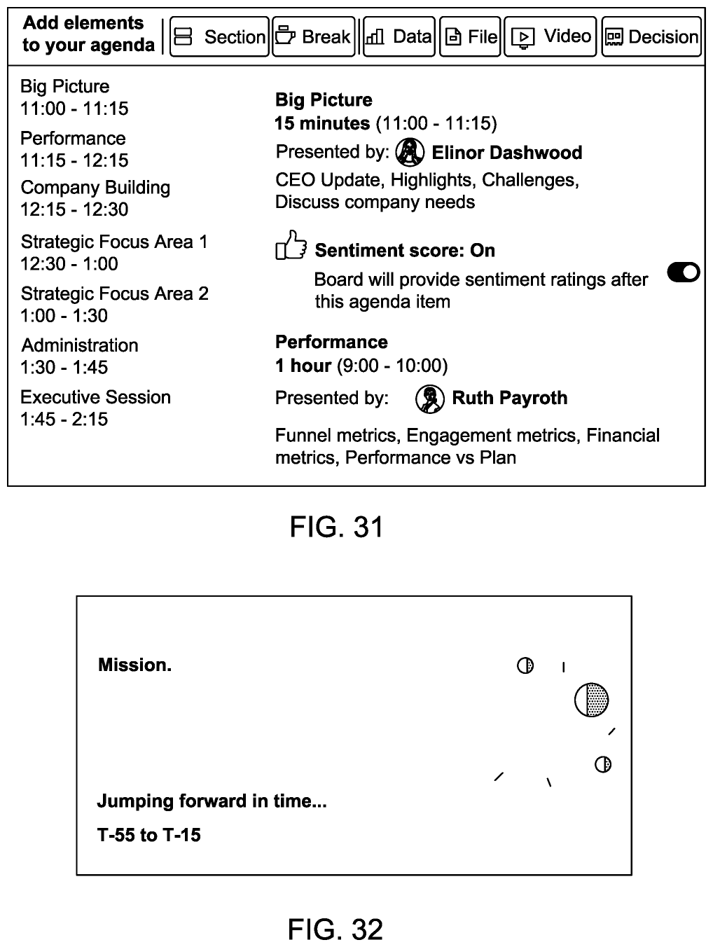

FIGS. 30 and 31

In FIGS. 30 and 31, like most quarters, she starts with the previous board meeting as a template. Once that's chosen, she's in the board book builder, where she can completely customize the agenda and assign sections.

In this case, all the sections are already pre-assigned for her team due to her chosen template. The platform Board Book templates also include PPT templates for agenda items such as Product update, Financial Summary etc

Elinor decides to add a new agenda item section to review North Stars, makes the duration 15 minutes, and assigns the presenter as her CFO, Ruth Payroth. Ruth will be notified and will populate the agenda item content.

Elinor clicks Save changes.

FIG. 32

In FIG. 32, we'll jump forward in time a couple weeks, to T-15. In the meantime, Elinor has been following the system recommended preparation schedule—talking to the board Chair and soliciting feedback from other BOD members; and giving her board a deadline for any questions they have before setting the final agenda.

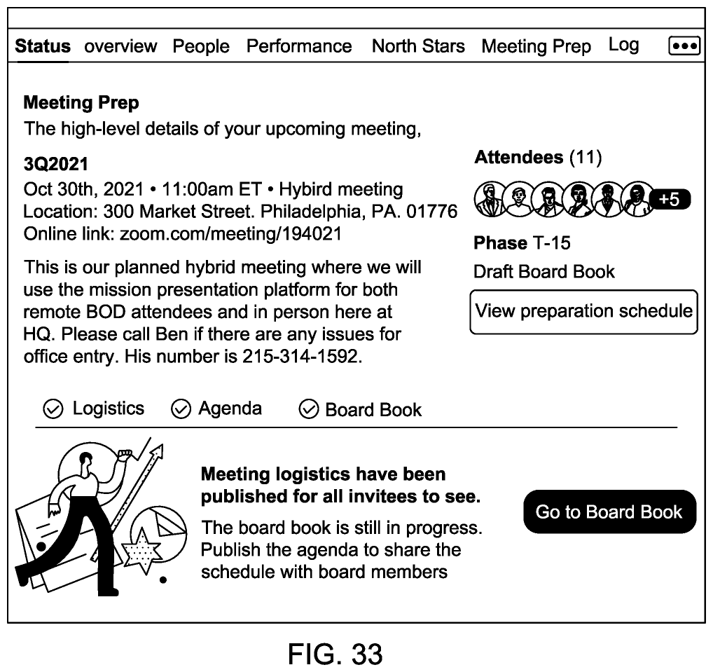

FIG. 33

In FIG. 33, Elinor opens Mission and jumps straight to the Board Book in progress, to see how her team is doing putting together the materials. She sees that her team has added the minutes from last meeting to the top-level agenda item, uploaded as an attached file.

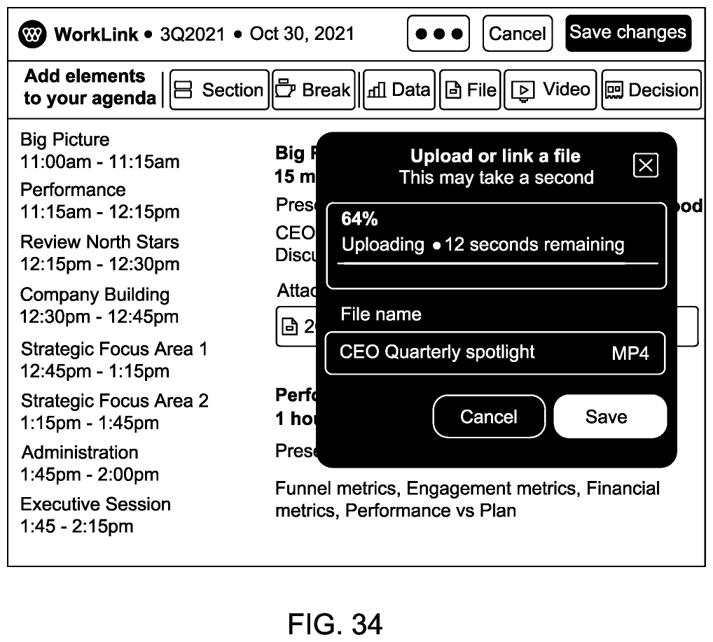

FIG. 34

In FIG. 34, Elinor has her 5 minute video spotlight ready to upload to the board book. She goes into edit mode, and goes ahead and drags in a video block and uploads her local video file, which adds the video directly in-line to the Board Book content. She saves her changes.

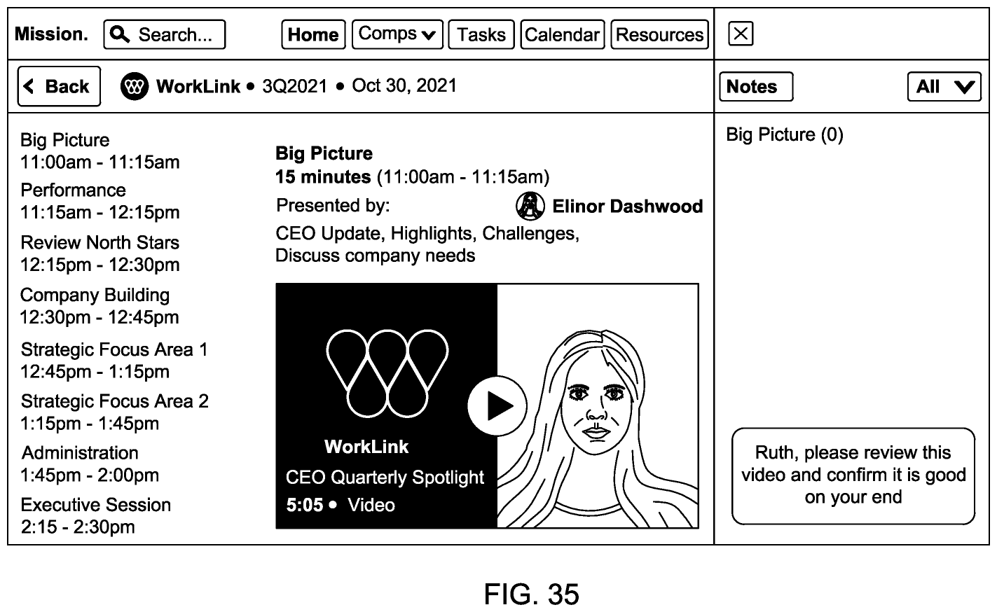

FIG. 35

In FIG. 35, she wants some internal feedback on her video, specifically from Ruth, so she opens the Notes tab and leaves a comment, asking Ruth to take a look. She sets the audience to the comment as internal, rather than the default private setting.

She knows the board book is still in progress, but feels confident about the agenda items and meeting flow.

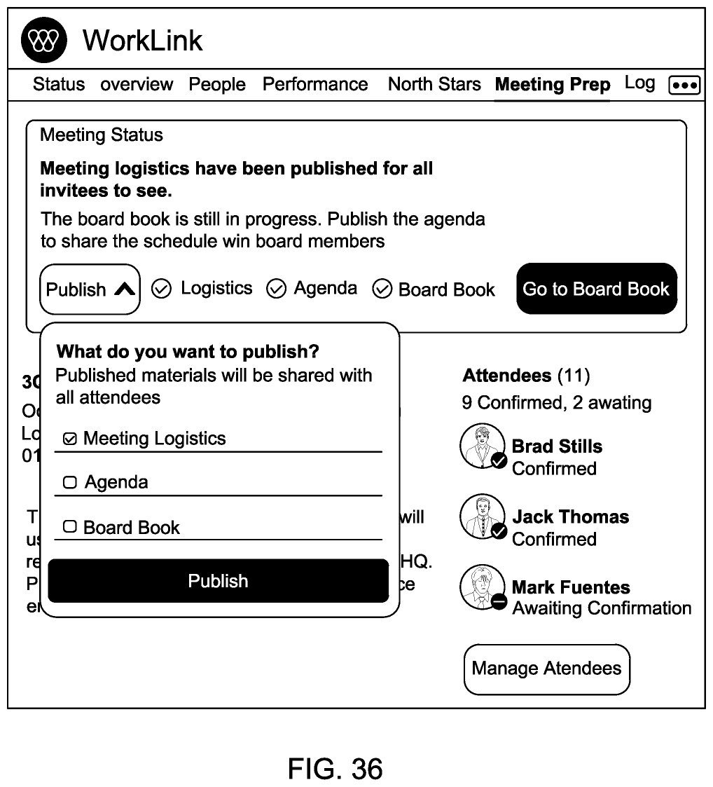

FIG. 36

In FIG. 36, back in the Meeting prep page, Elinor reviews the agenda and confirms it all looks good to go. She publishes the agenda, informing the board members that the meeting schedule is finalized.

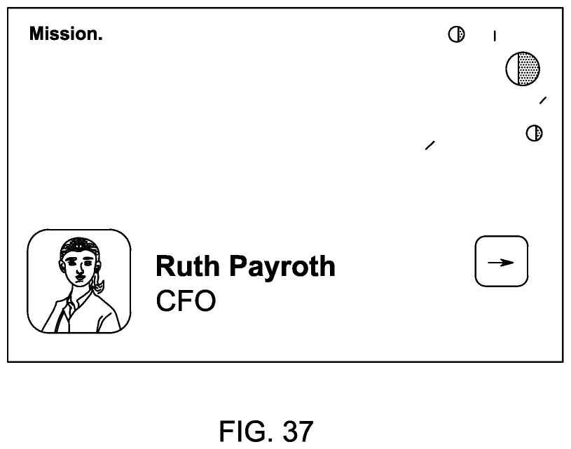

FIG. 37

Now we'll see how WorkLink's CFO, Ruth Payroth, uses the Mission platform, as shown in FIG. 37.

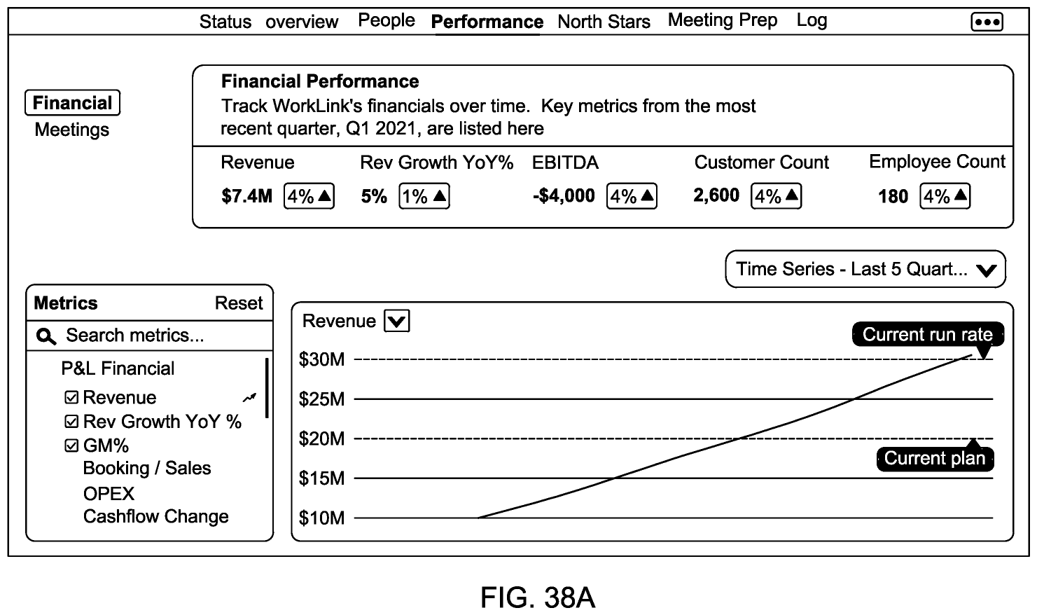

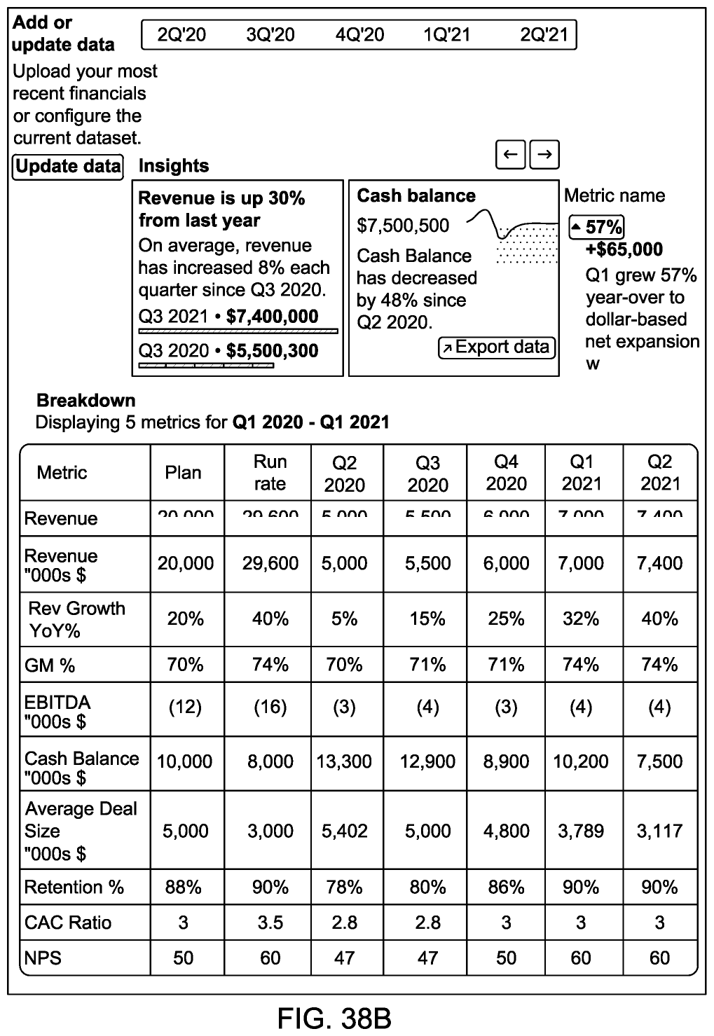

FIGS. 38A-C

In FIGS. 38A-C, in the Performance section, Ruth can monitor the financial trends of WorkLink based off the latest quarterly data she uploaded. At the top, she sees the 5 key metrics for the company. Then she sees a graph of the company's revenue compared to their current run rate and plan.

Intelligent insights from the Mission platform highlight important data-driven findings, such as a notable rise in a metric compared to last year.

FIG. 38D

In FIG. 38D, she can also review the table to see all of her company's metrics for the last 5 quarters. She wants to see the Customer Count as well, and she knows that Mission has a full set of automated operating metrics to choose from for her own data, so she clicks the checkmark to activate Customer Count in her data table.

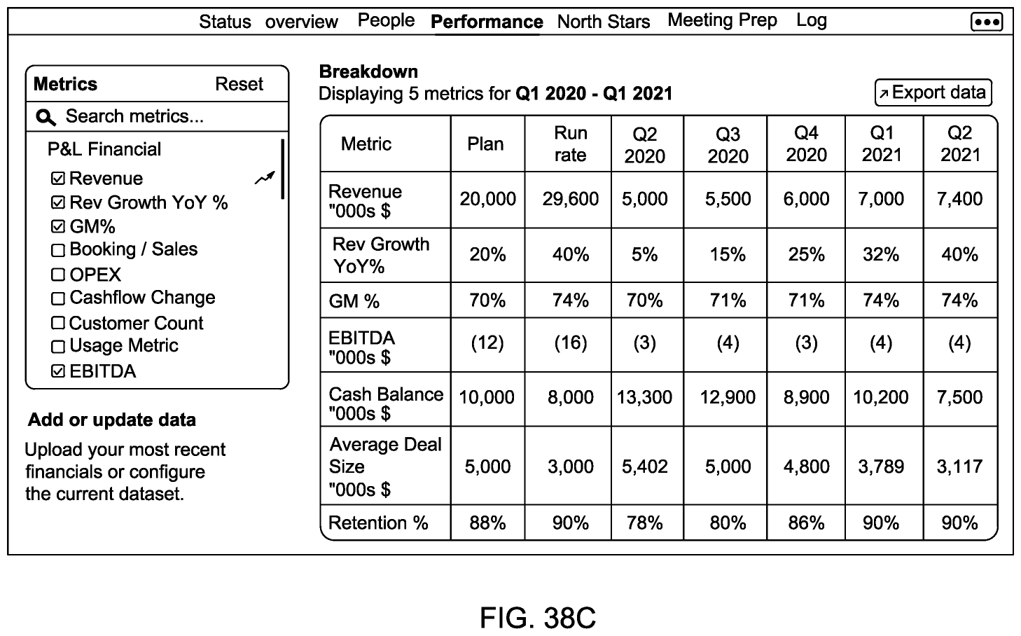

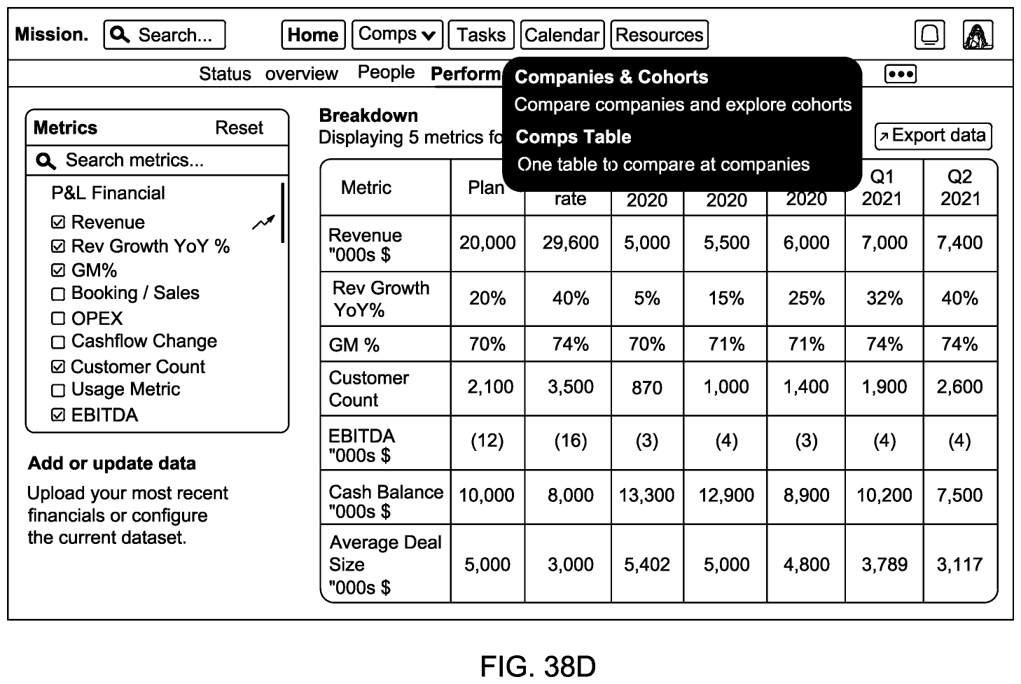

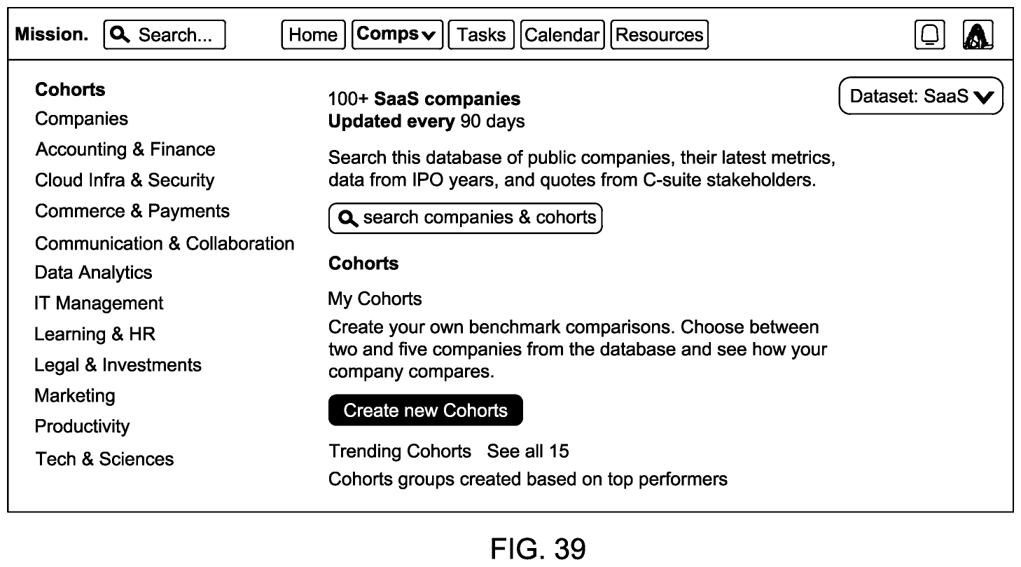

FIG. 39

In FIG. 39, after reviewing their performance data, Ruth is ready to add a new North Star for WorkLink. She goes to the Comps section and selects Companies & Cohorts.

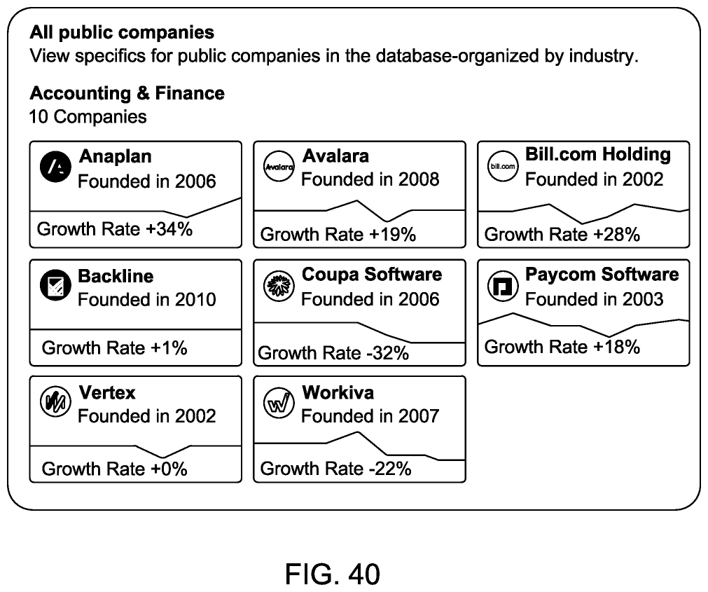

FIG. 40

In FIG. 40, here she sees the full list of over 100 companies including all SaaS IPOs since the year 2000 in the platform's database sorted by industry

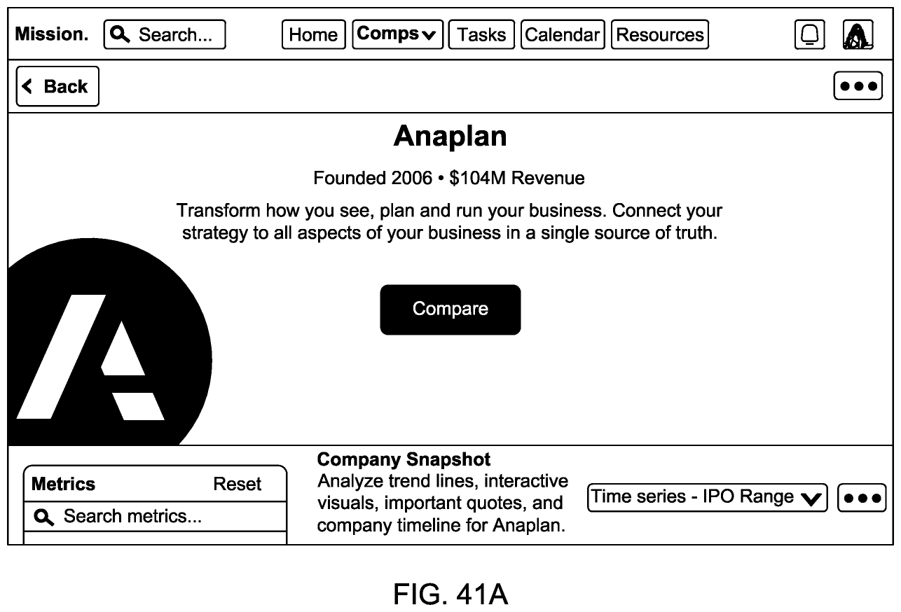

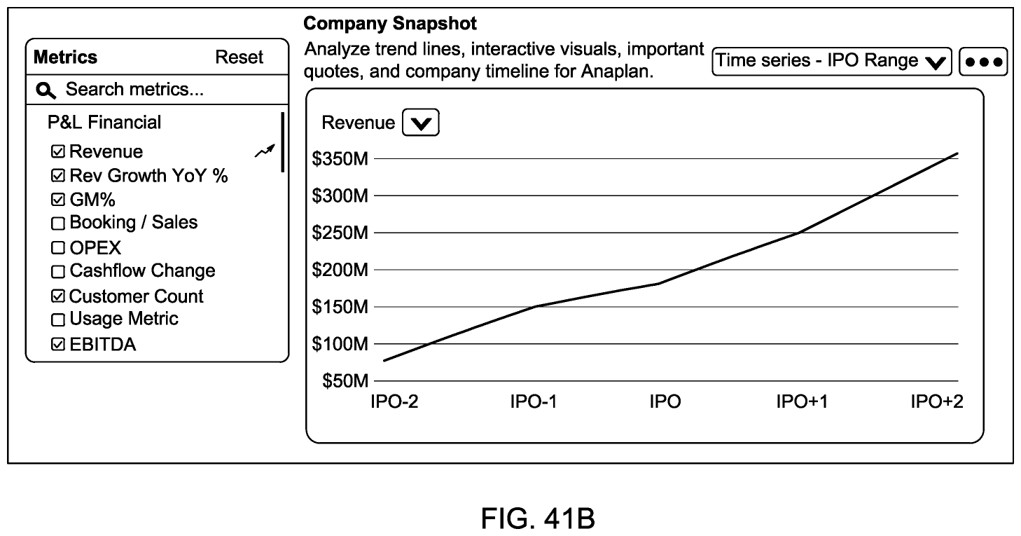

FIGS. 41A and 41B

In FIGS. 41A and 41B, the North Star Ruth has been thinking about for a while is Anaplan. She sees Anaplan in the list of companies under the Accounting & Finance industry, and clicks the company card to go to its page.

For every public company in the Mission Comps database, there is a detailed page with current data and IPO data, especially the two years before the companies went IPO. This customized data for IPO minus two years and IPO minus one year are the most instructive and useful to any private PE or VC backed company building to a billion. Every company page will also have intelligent insights and scraped CEO quotes, and a company timeline with key funding milestones.

For every public company in the Mission Comps database, there is a detailed page with current data and IPO data, especially the two years before the companies went IPO. This customized data for IPO minus two years and IPO minus one year are the most instructive and useful to any private PE or VC backed company building to a billion. Every company page will also have intelligent insights and scraped CEO quotes, and a company timeline with key funding milestones.

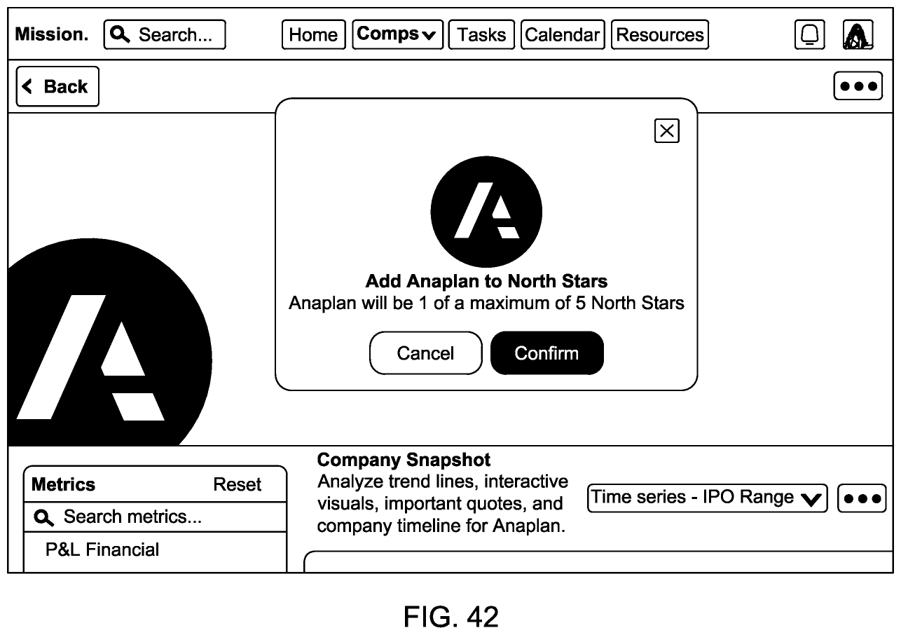

FIG. 42

In FIG. 42, after taking a look through Anaplan's details, Ruth decides this is a great company to add to WorkLink's North Stars.

She clicks “Add to North Stars,” and goes to the North Stars page to take a look.

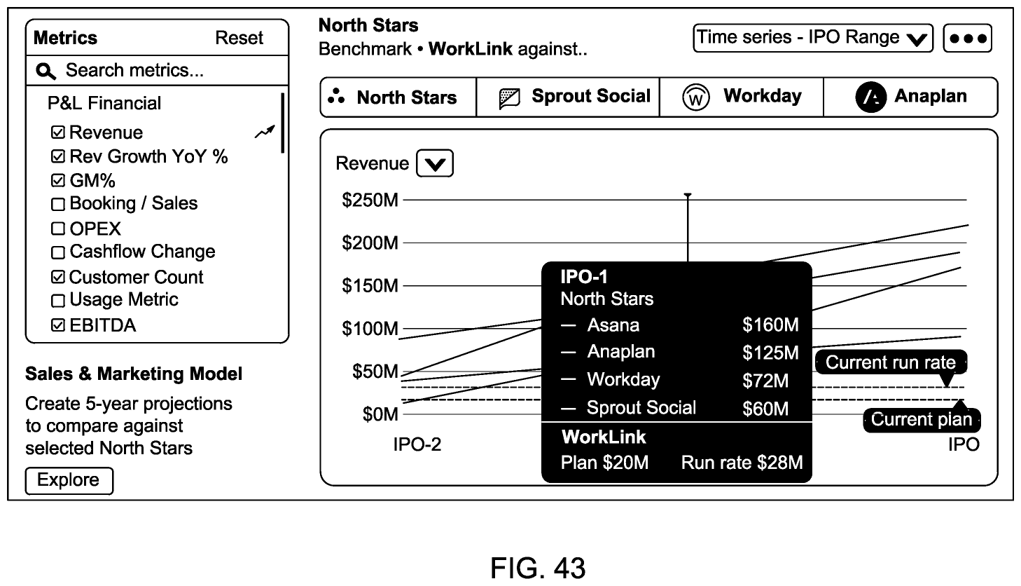

FIG. 43

In FIG. 43, here in WorkLink's North Stars page, all board members can see how WorkLink compares to their chosen North Star companies. The default view shows the 4 North Stars' data before their IPO, benchmarking against WorkLink's current Run rate and Plan. She sees that their run rate and plan is relatively close to these North Star's revenue 2 years before IPO. When learning about the smaller size of Anaplan two years before IPO versus Anaplan in 2021, she begins to feel more excited and confident that WorkLink can reach equal size and scale of Anaplan's pre IPO numbers within two years. She knows this data and illustrations is a great strategic topic for the upcoming Board meeting. She copies the share link and sends the page to Elinor for her approval.

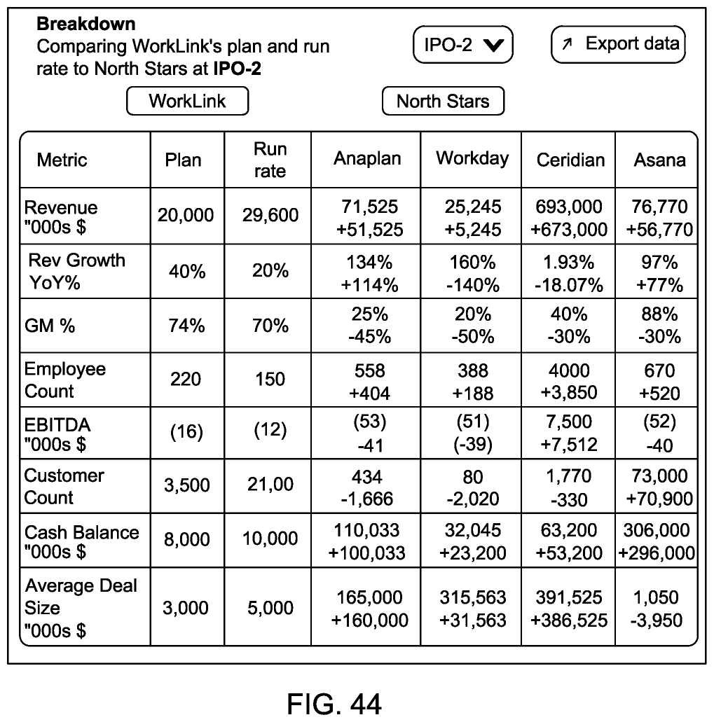

FIG. 44

In FIG. 44, further down on the page, the table will show her the delta values of exactly how WorkLink's run rate compares to the North Stars at two years before IPO for each metric she has specified.

Ruth decides to run a growth projection using the Sales & Marketing model, as she thinks that will be a highly useful tool for the upcoming board meeting, to prove that WorkLink has high potential for breakaway growth.

FIG. 43

In FIG. 43, here in WorkLink's North Stars page, all board members can see how WorkLink compares to their chosen North Star companies. The default view shows the 4 North Stars' data before their IPO, benchmarking against WorkLink's current Run rate and Plan. She sees that their run rate and plan is relatively close to these North Star's revenue 2 years before IPO. When learning about the smaller size of Anaplan two years before IPO versus Anaplan in 2021, she begins to feel more excited and confident that WorkLink can reach equal size and scale of Anaplan's pre IPO numbers within two years. She knows this data and illustrations is a great strategic topic for the upcoming Board meeting. She copies the share link and sends the page to Elinor for her approval.

FIG. 44

In FIG. 44, further down on the page, the table will show her the delta values of exactly how WorkLink's run rate compares to the North Stars at two years before IPO for each metric she has specified.

Ruth decides to run a growth projection using the Sales & Marketing model, as she thinks that will be a highly useful tool for the upcoming board meeting, to prove that WorkLink has high potential for breakaway growth.

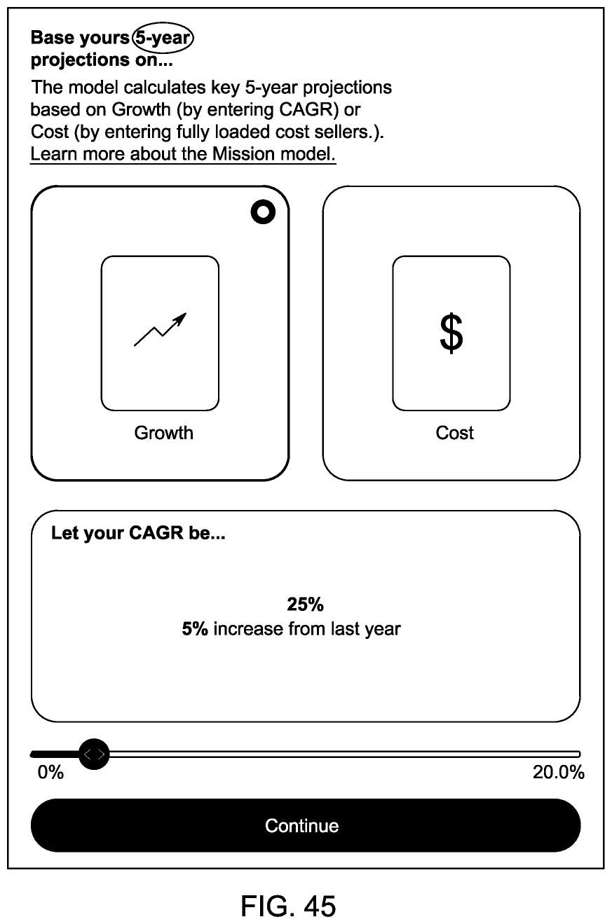

FIG. 45

In the Sales & Marketing model, Ruth chooses to run a Growth projection and defines the CAGR as 25%.

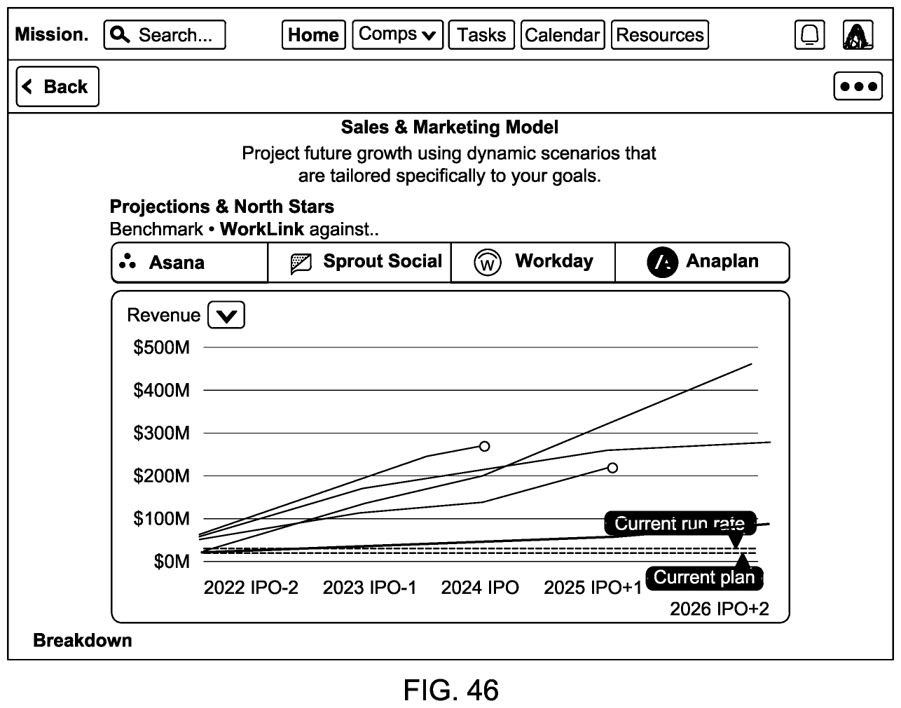

FIG. 46

In FIG. 46, now she sees WorkLink's 5-year projections compared against the North Stars' IPO range.

She's liking the trend, and adds the data page to the Board Book for the Q3 meeting—specifically for the Review North Stars agenda item which Elinor assigned to her.

Soon enough, she gets a notification—a note from Elinor on the Board Book asking her to run the projection with an increased CAGR. Ruth quickly clicks Update projection data and enters in 50% as the new CAGR.

Yes, that's more like it, she thinks, seeing that this model projects they will clear $100M in revenue by 2025. Scrolling down, she looks at the table, which indicates the specific projection values for each year compared to the North Stars.

She knows this is perfect for the Board who has been asking for more growth scenarios. She knows this is a market based, unique and effective process to discuss different scenarios of growth to burn over the next two years. She′ll add this version to the Board Book instead.

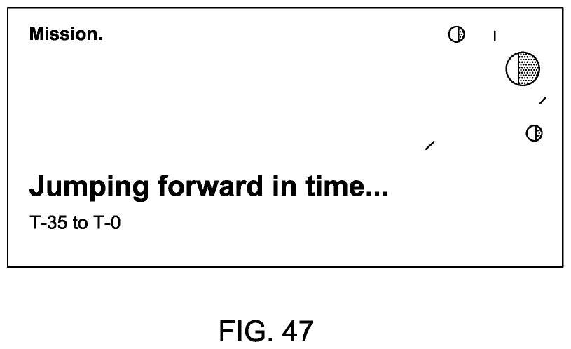

FIG. 47

In FIG. 47, jumping in time a couple weeks forward, to the day of the Q3 board meeting . . . .

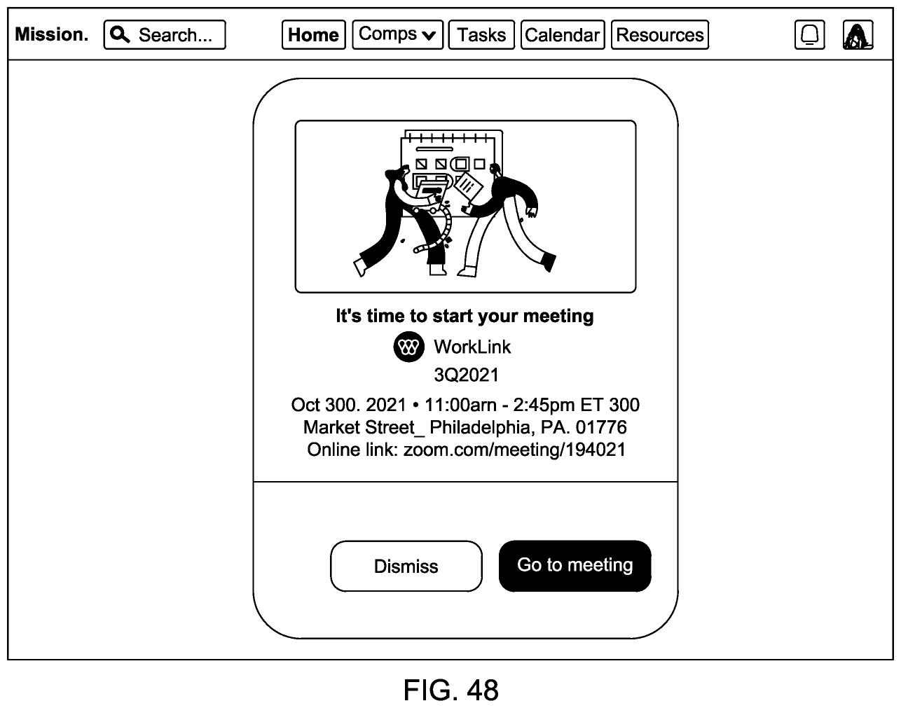

FIG. 48

In FIG. 48, Ruth opens Mission and sees a notification that she needs to start the meeting. She goes to the meeting and enters Mission's live meeting presentation mode.

As the CFO, it is Ruth's role to be the live meeting administrator, including managing the participants and waiting room and officially advancing the meeting from agenda item to agenda item.

Once they have reached quorum, Ruth clicks Start Meeting. This officially kicks off the live meeting and shows the first agenda item, Big Picture, as active. Elinor shares her screen, and plays her CEO Quarterly Spotlight video.

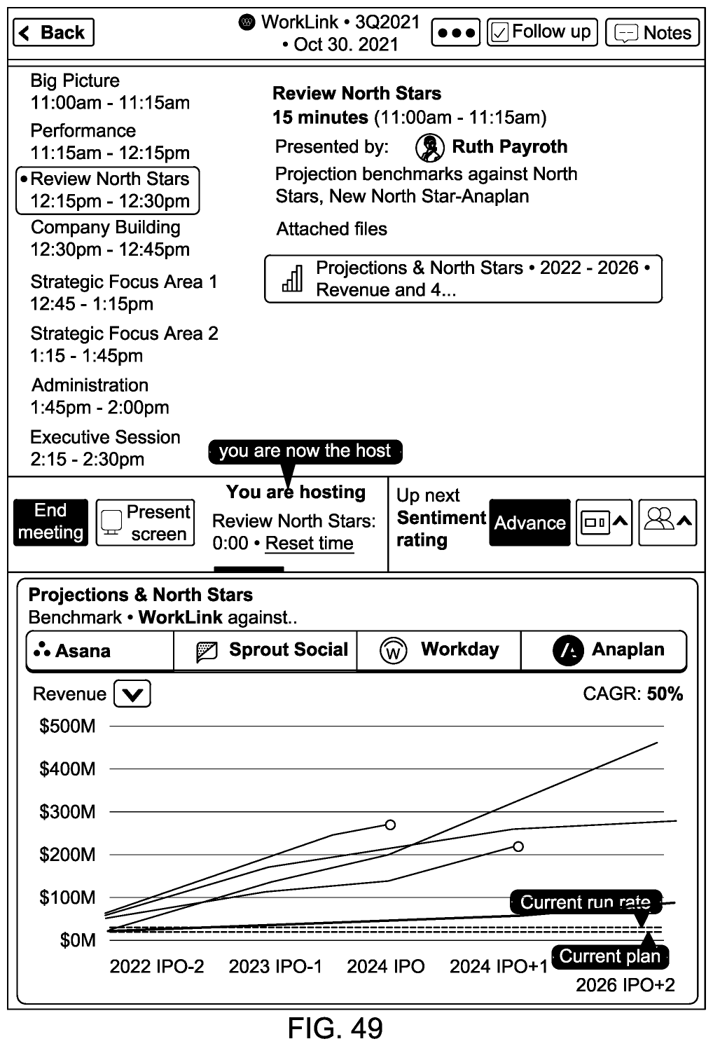

FIG. 49

In FIG. 49, as the meeting progresses, it is time for Ruth to present the Review North Stars agenda item. She sees a message that lets her know she is now the host.

She clicks “Present screen” and chooses her Projections & North Stars data chart from the attached agenda files.

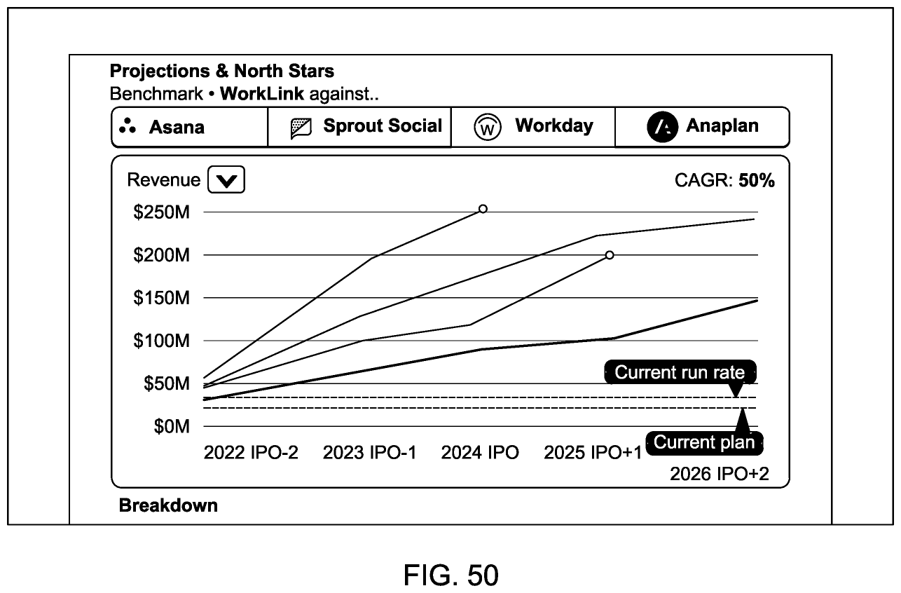

FIG. 50

In FIG. 50, now she's able to share her screen and point to the Sales & Marketing model's graph and data table. She can even interact with the chart, such as changing the featured metric or toggling North Stars on and off. She decides to toggle Workday off so they can focus more on the North Stars under $300M in revenue.

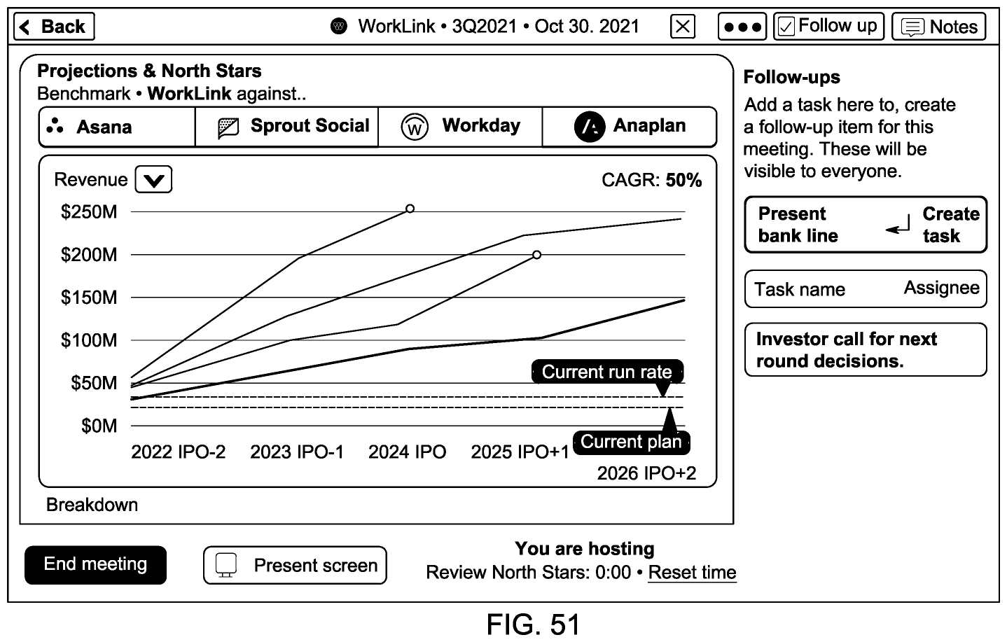

FIG. 51

In FIG. 51, as the board reacts to her presentation, Ruth uses the follow-up window to add a follow-up item to Present bank line options, for all members to see. She can fill in the details such as due date and assignee later.

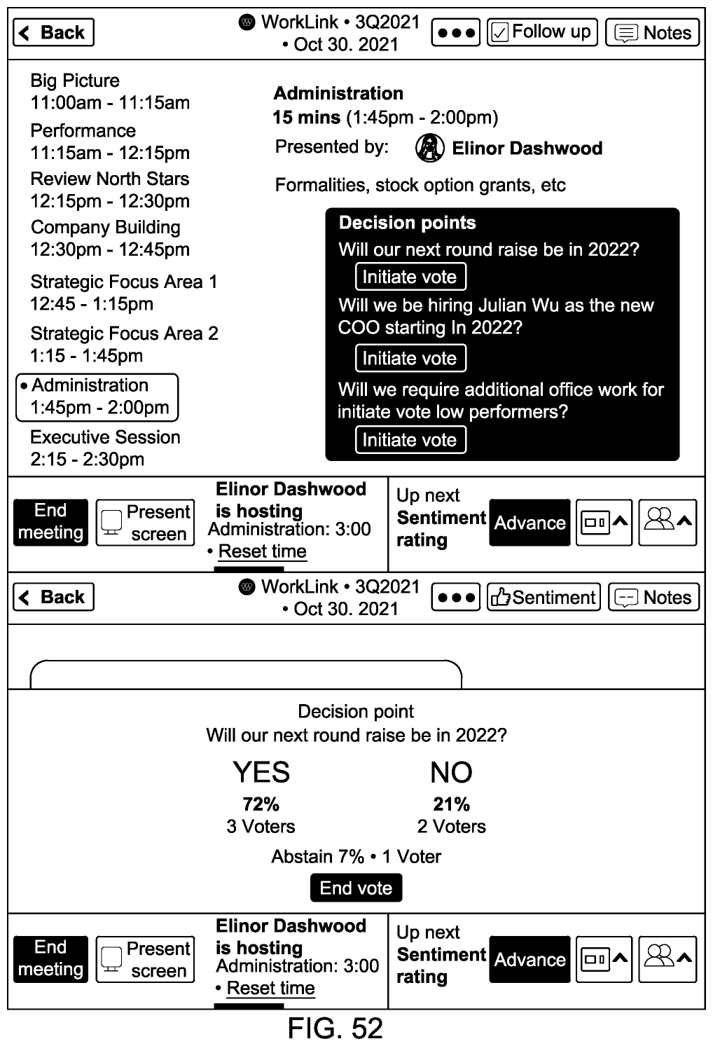

FIG. 52

In FIG. 52, later in the meeting, during the Administration portion, Ruth initiates the decision point vote for whether WorkLink's next round will be in 2022.

She sees the votes come in live as the board members vote. Once the results are all in, she clicks Continue

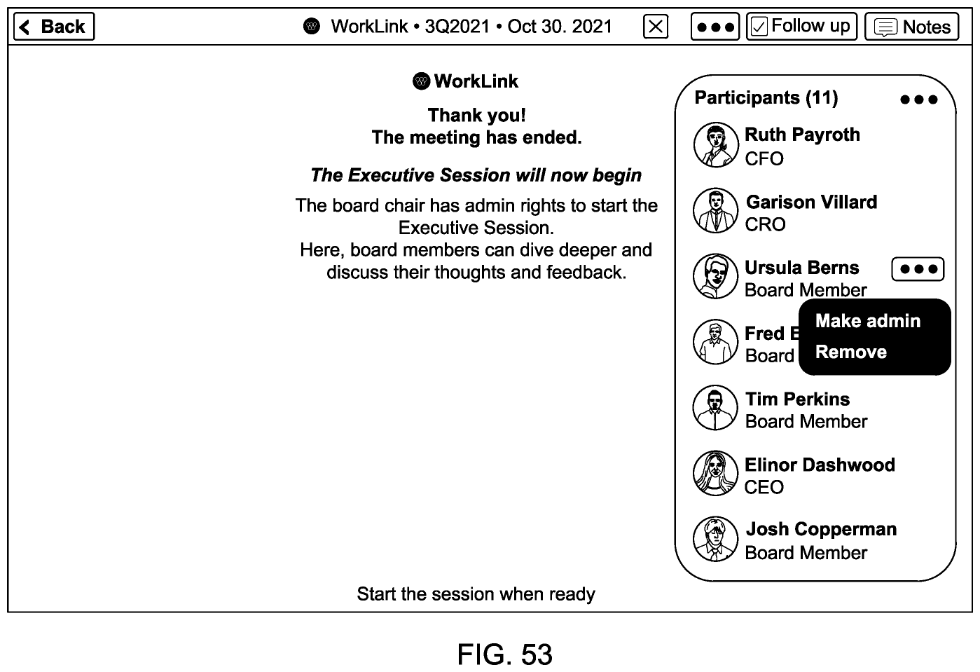

FIG. 53

In FIG. 53, finally, as they reach the last agenda item, Ruth transfers the administrator rights to the Board Chair per Elinor's request and they take off, leaving the board to discuss the meeting, review collective sentiment ratings, and any private notes written during the meeting.

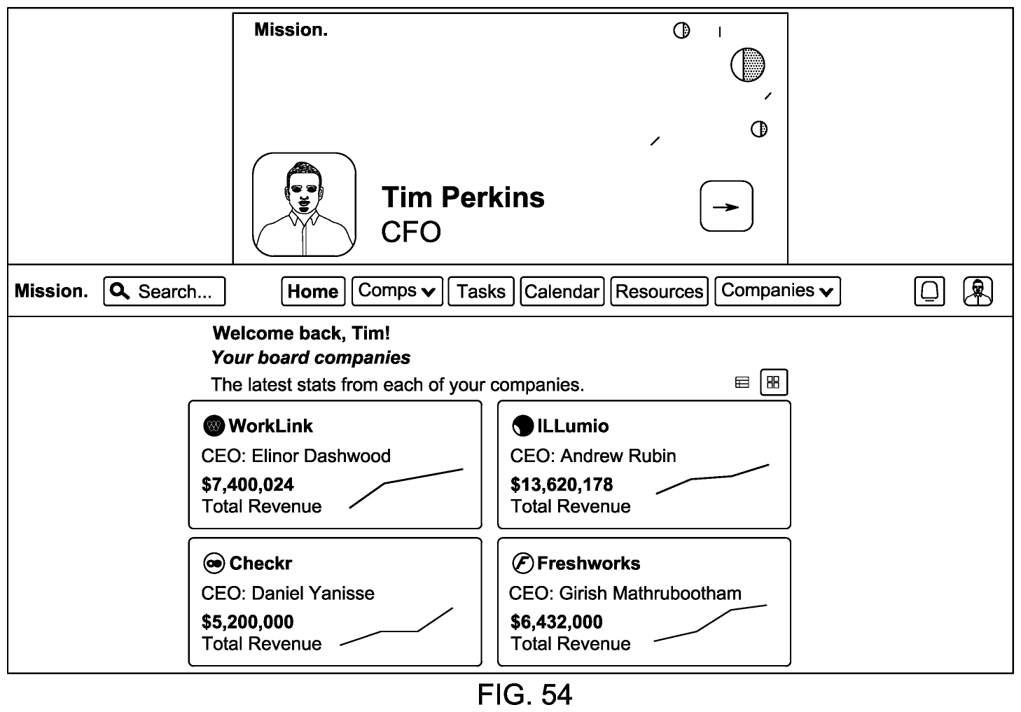

FIG. 54

In FIG. 54, finally, we'll look at how Tim Perkins, a board member of WorkLink, uses Mission to manage the 4 company boards he is a part of.

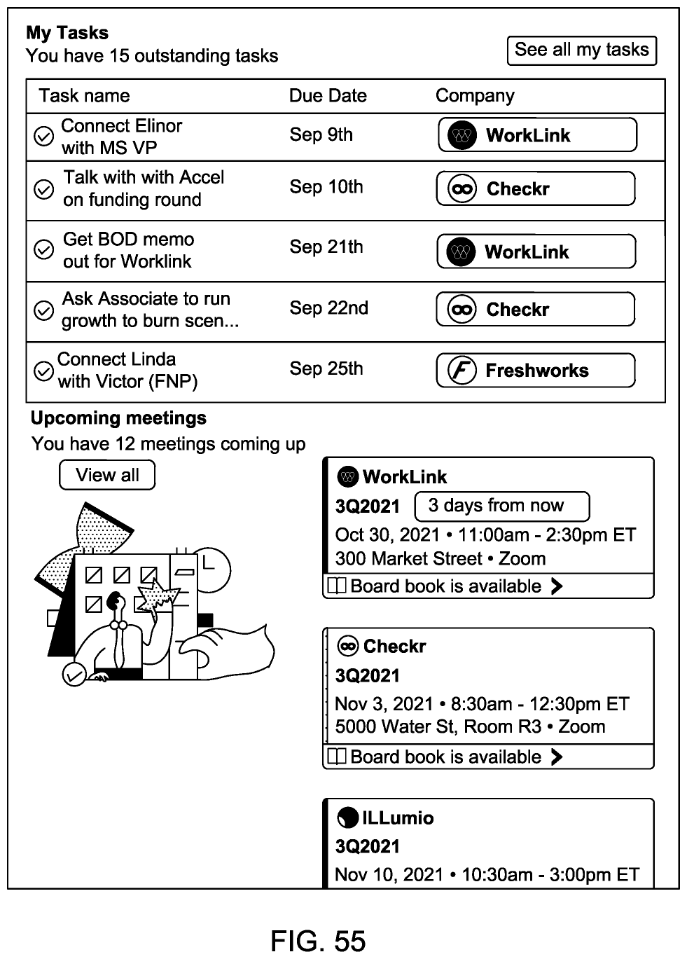

FIG. 55

In FIG. 55, logging into the Mission platform, TIm sees his homepage which shows an overview of his portfolio companies. On his homepage, he also can quickly get a sense of his most pressing Tasks and Upcoming Meetings across all of his companies. He takes a look at his upcoming tasks, and then scrolls to the meetings.

He notes that the Q3 meeting for WorkLink is in 3 days from now, and the Board Book is available.

That reminds him, he wanted to create a cohort analysis to compare against WorkLink, and recommend some new North Stars to the WorkLink executive team.

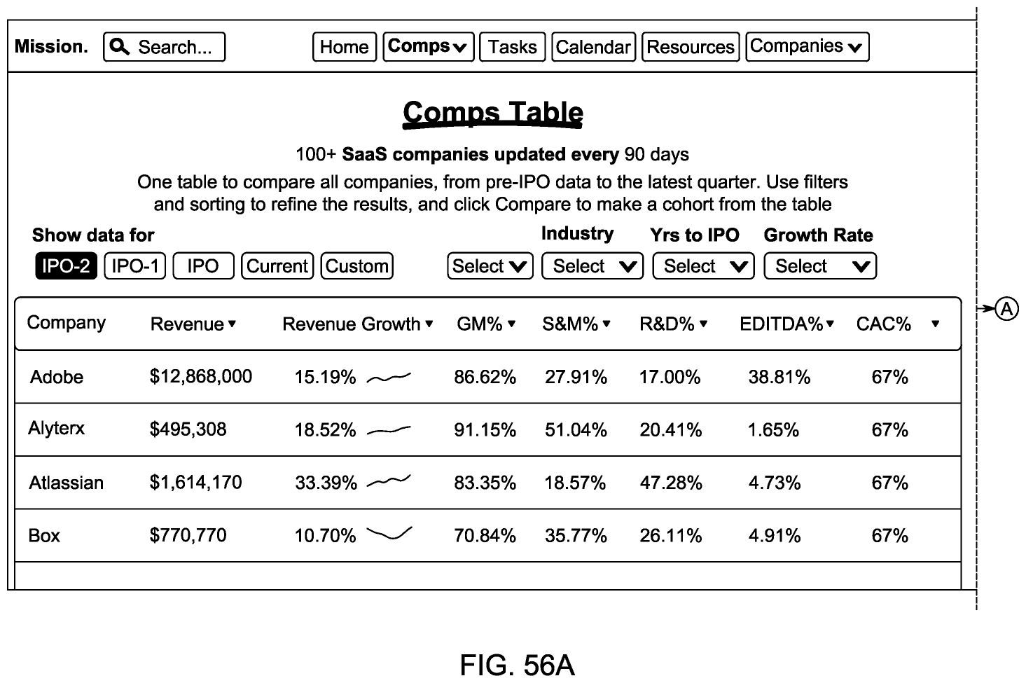

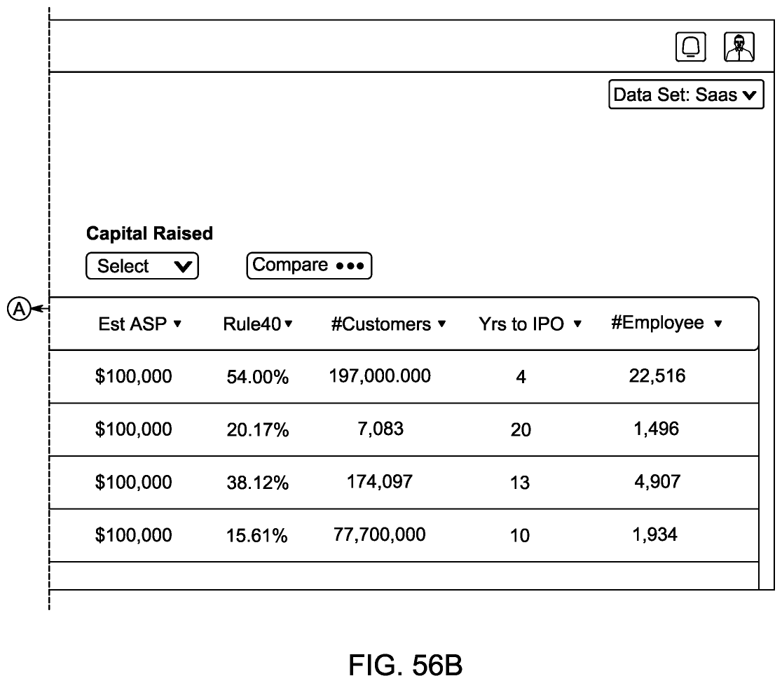

FIG. 56

In FIG. 56, he asks a Principal in his venture firm to join him to access the Comps Table in the Comps section and take a look at the landscape of data from the public companies two years before the IPO.

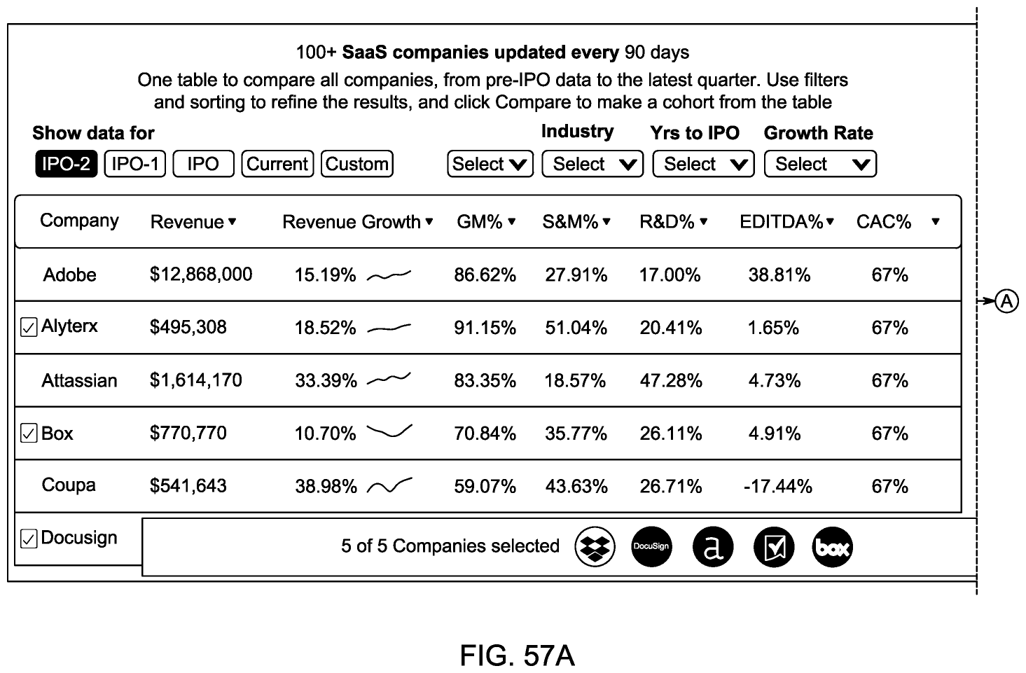

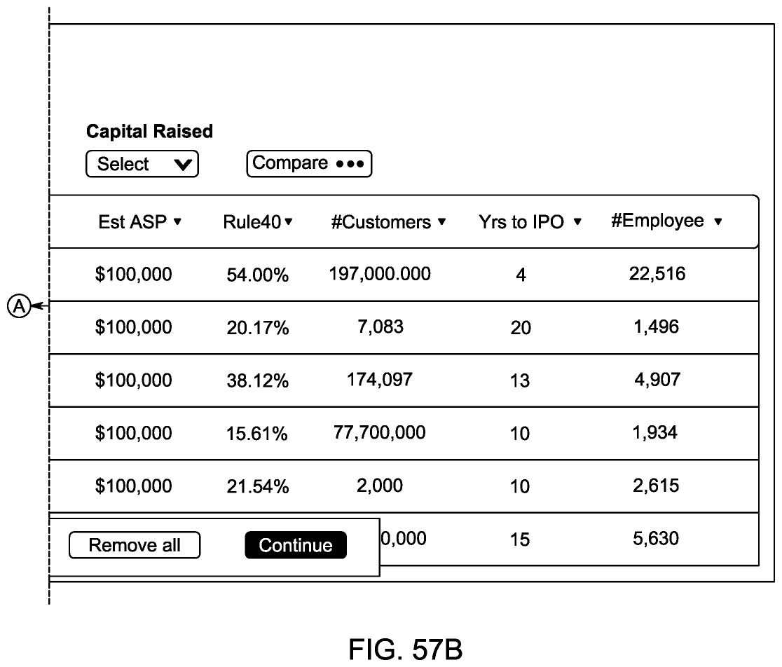

FIG. 57

In FIG. 57, here they click Compare and begin creating a cohort.

They choose Dropbox, DocuSign, Alteryx, Smartsheet, and Box.

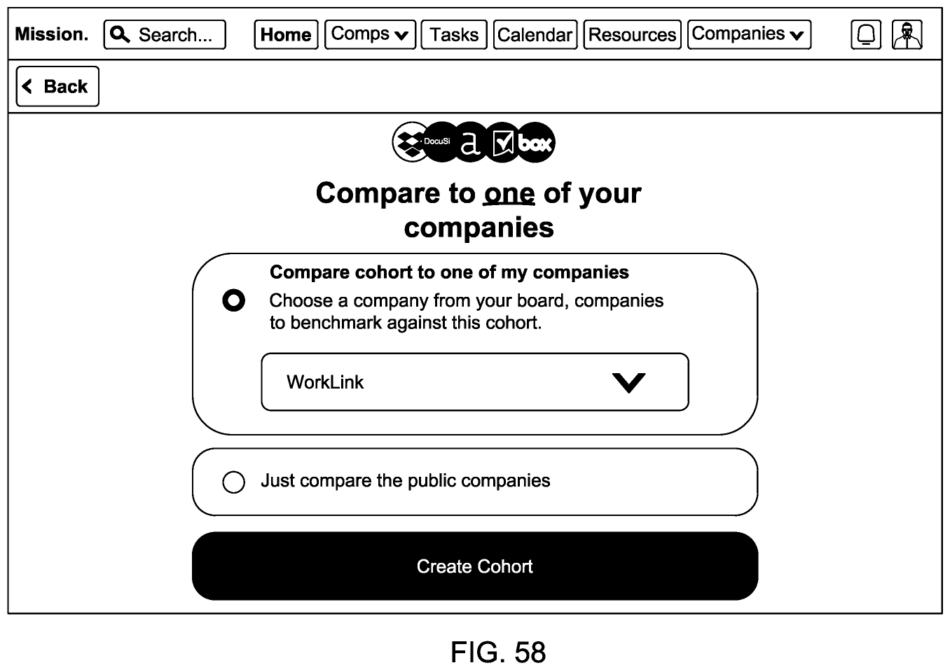

FIG. 58

In FIG. 58, in this case, Tim wants to compare against WorkLink. He selects Create Cohort and comes to the Cohort Comparison page.

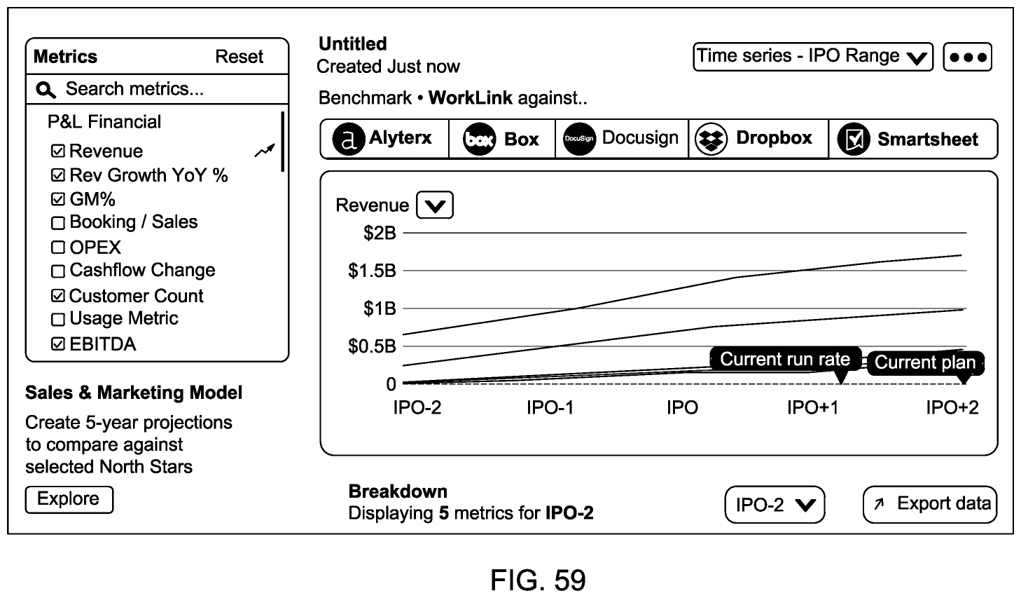

FIG. 59

In FIG. 59, here he sees WorkLink's run rate and plan compared against the IPO data from the 5 companies he selected.

He can also run Sales & Marketing model growth projections from this page, like in the North Stars section.

He renames the cohort to “Additional North Star Ideas” and clicks Share. Here he can download a PDF or copy a share link to the interactive page. He click copy share link and copies the link to send to Elinor and Ruth.

Then, he clicks on WorkLink to go to their Company page.

Here, he lands on the Overview page of WorkLink. Every time he lands on a company page, he's presented with their vision statement, their key company details and current performance metrics.

He also takes a look at the Three Year Vision which Elinor has laid out, which looks at Marketplace landscape and key internal drivers.

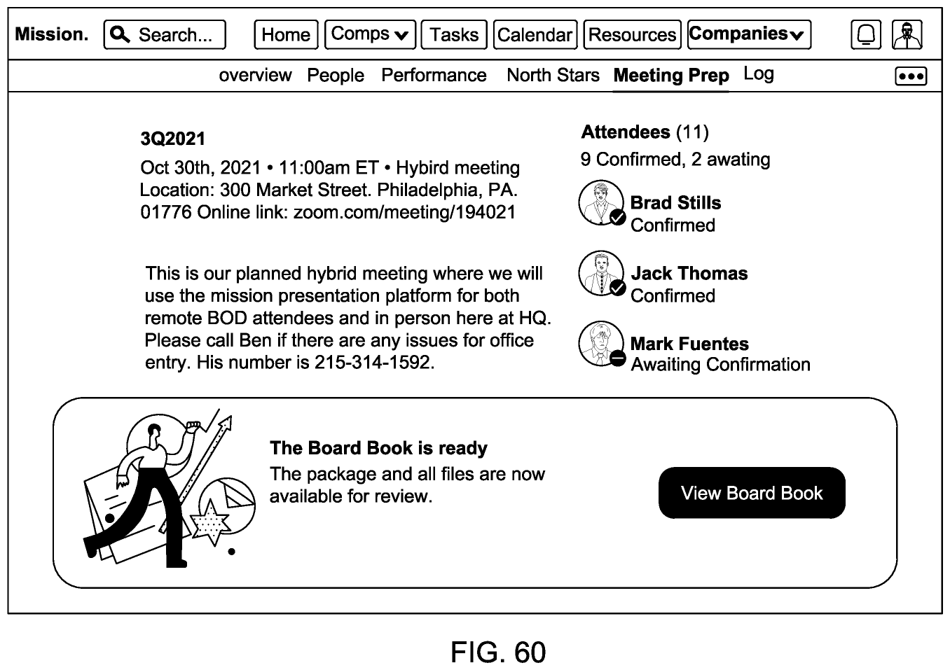

FIG. 60

In FIG. 60, Tim clicks on the Meeting Prep tab to see all the information for the upcoming meeting, including the date, the location, and the agenda. Right at the top, he sees that the Board Book is ready, and he clicks View Board Book to dive in.

Here, he looks through the long-form Board Book package, which includes last meeting's minutes, Elinor's video spotlight, Performance spreadsheets, North Star graphs and more.

He clicks Download, in order to download the package and view it offline, but he appreciates that he can always return to the Board Book link to view the package and files, even on his phone.

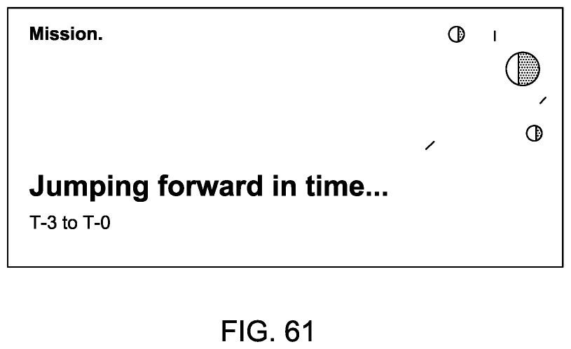

FIG. 61

In FIG. 61, jumping forward in time 3 days to T-0, Tim is in the live meeting while Ruth is sharing her screen and walking through the latest North Star projections.

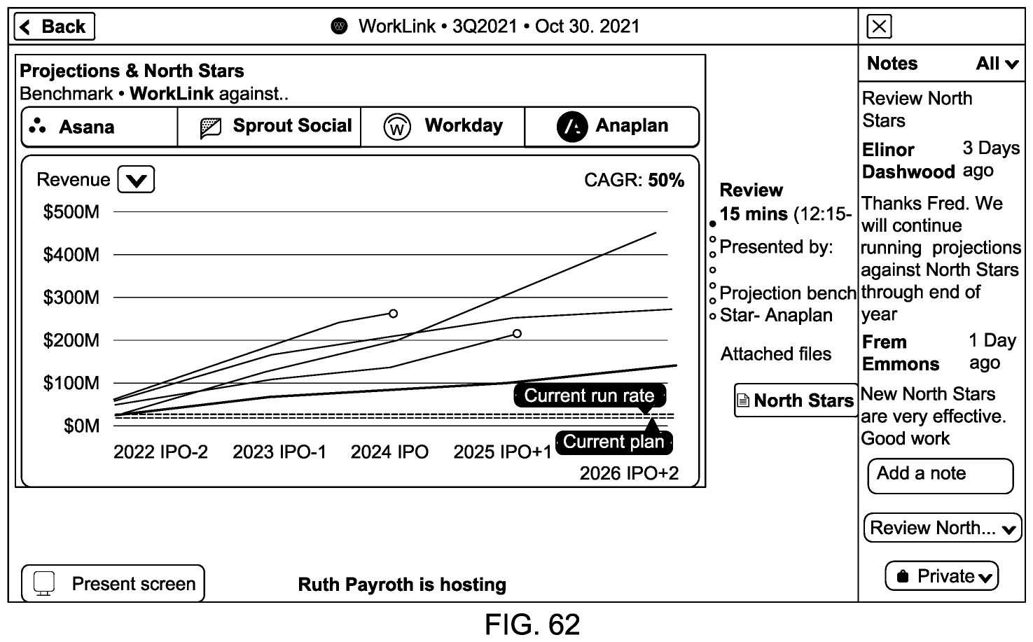

FIG. 62

In FIG. 62, he opens the Notes pane and enters in a private note to remind himself of something to bring up during the executive session.

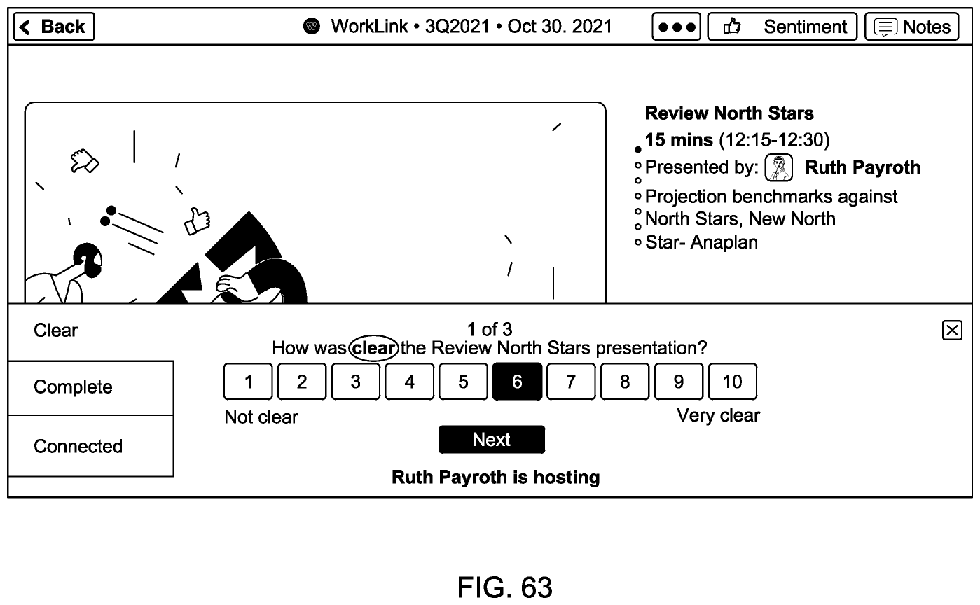

FIG. 63

In FIG. 63, after Ruth is done with her presentation on the North Stars, it's time for the board to give quantitative sentiment ratings. Tim rates Ruth's presentation on how clear it was, how complete it was, and how connected it was. He adds some additional color in the comments section, for Elinor to review, and clicks Submit sentiment scores.

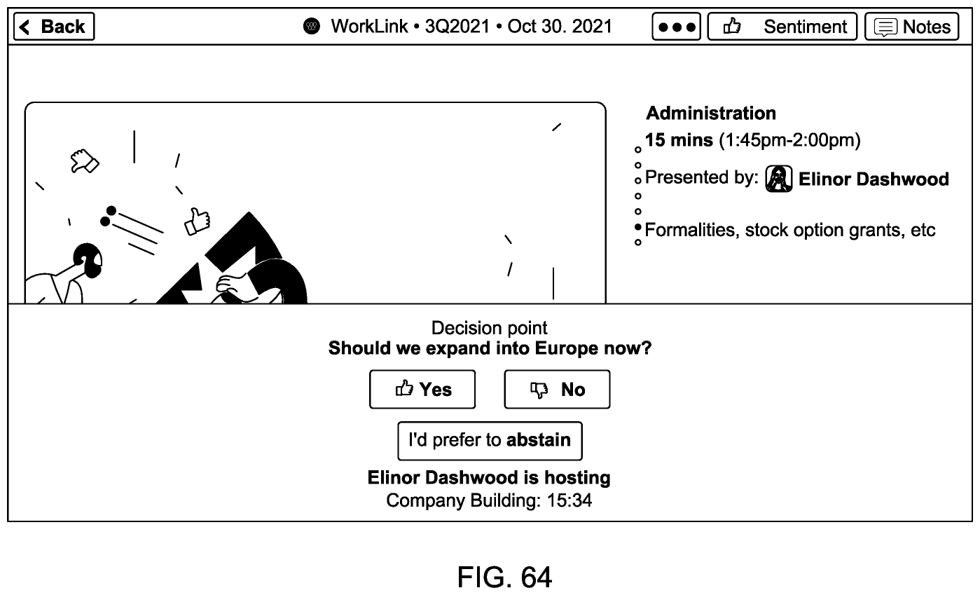

FIG. 64

In FIG. 64, later, in the Administration portion of the meeting, Tim votes No to the question of whether WorkLink should expand to Europe.

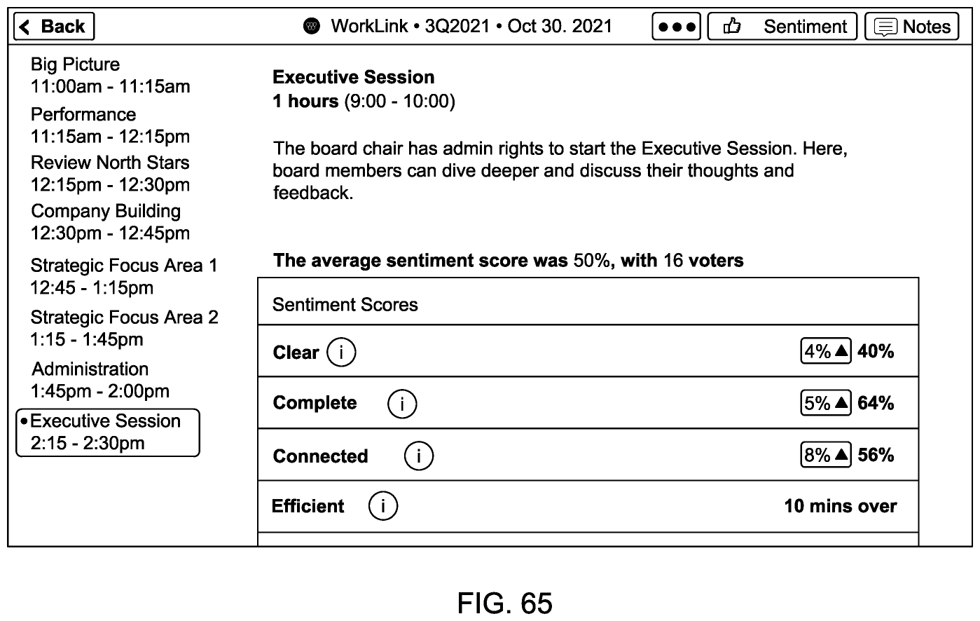

FIG. 65

In FIG. 65, once WorkLink is done with their presentation, it is time for the Executive Session. The WorkLink team leaves and the board proceeds to the meeting summary portion of the meeting, where the results of the meeting, including sentiment ratings, decision points, and follow ups, are displayed, and the board discusses their feedback.

They ping Elinor to come back into the exec session to share their sentiment results, notes and other executive summary data, and they have a productive discussion on the state of the company.

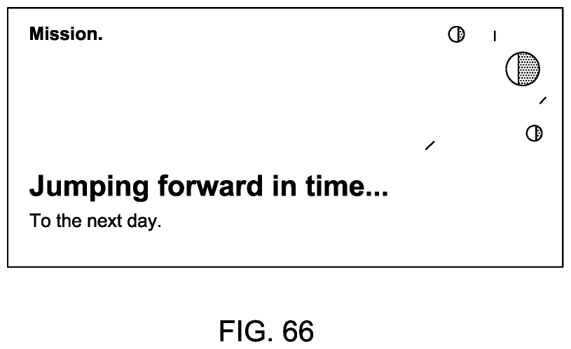

FIG. 66

In FIG. 66, jumping forward in time one day after the board meeting

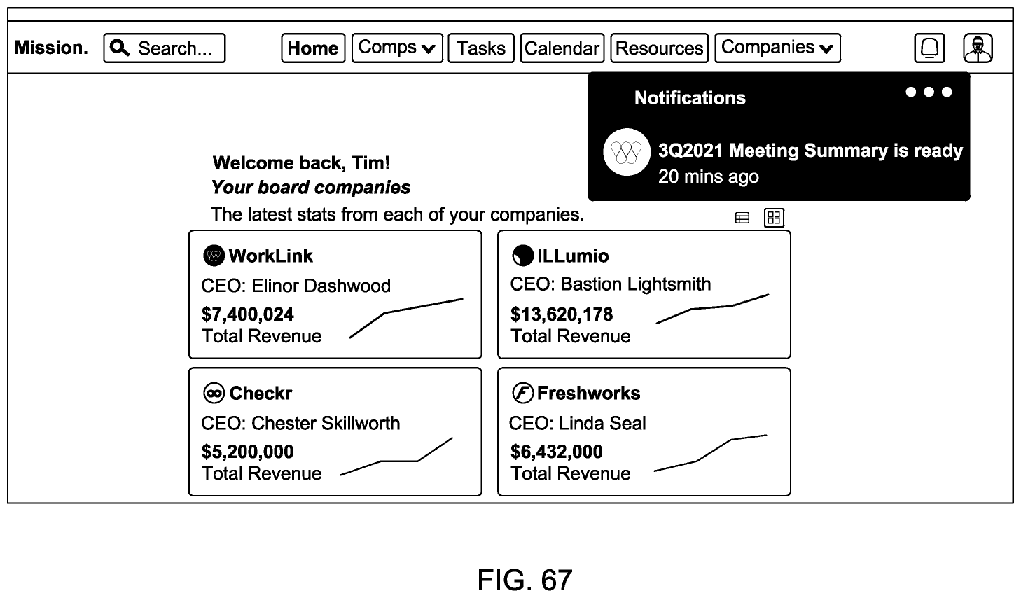

FIG. 67

In FIG. 67, Tim sees an email that the Meeting Summary is ready. Logging into Mission, he also sees an in-platform notification.

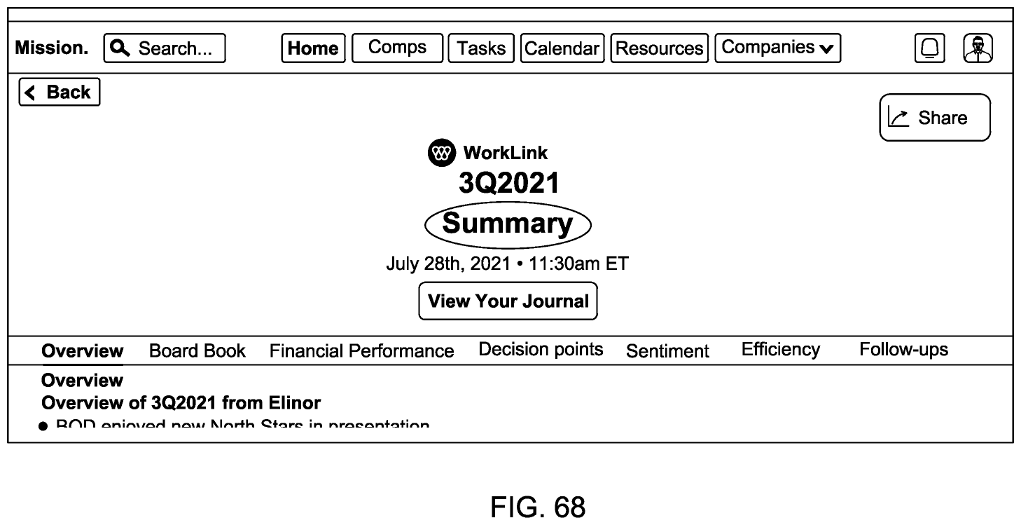

FIG. 68

In FIG. 68, he clicks this and it takes him straight to the Meeting Summary for WorkLink's Q3 meeting, including Elinor's overview of key takeaways for the board members. TIm knows that a record like this exists for every single one of his board meetings, which helps him keep track of the important decisions and action items from each meeting.

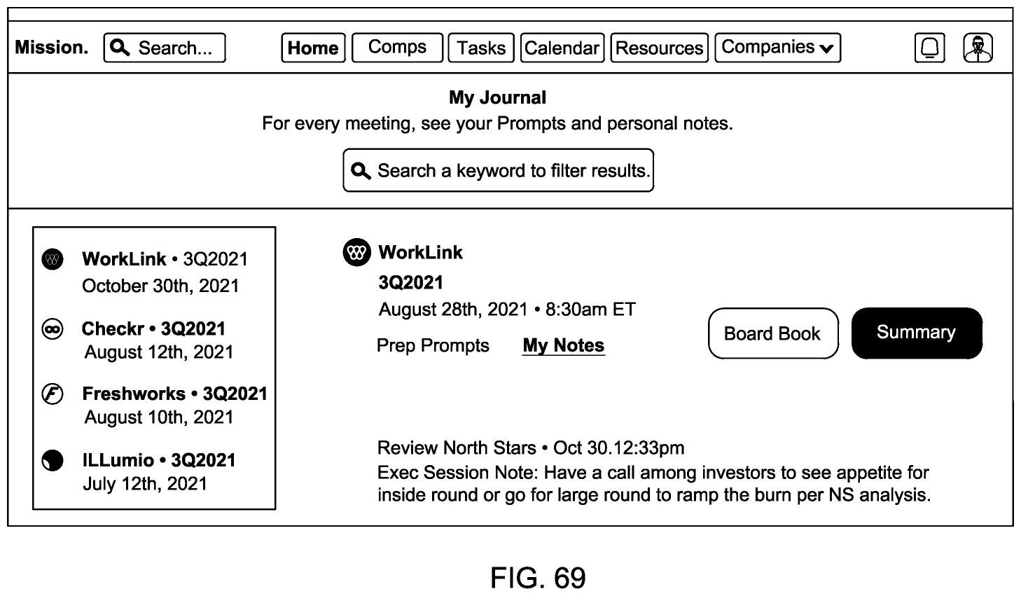

FIG. 69

In FIG. 69, furthermore, as he clicks Journal, Tim is glad to have all his personal notes in one place. Here he sees the private note he left during the meeting, as well as some public notes he left after reviewing the board book. He's able to search across his personal notes for every board meeting.

Conclusion of Demo Script

And that's a tour of Mission's key features.

An additional feature of the Mission product will be a proactive, single sheet snapshot of market trends, quotes and competitive information that is delivered to Board members in advance of the upcoming Board meeting.

The Resources section of Mission will include templates, preparation prompts and various tools for recurring and special Board agenda items. Examples of recurring board topics will be templated for Sales and Marketing, Product, KPI trees, ‘if/then’ models of growth, Sales compensation models, and more.

The product is also mobile enabled providing a system of intelligence, engagement and collaboration all on your phone.

Mission is a system to build better companies faster among CEOs, management and Board members committed for the long term.

### 7. Terms

Certain terms and phrases have been used throughout the disclosure and will have the following meanings in the context of the ongoing disclosure.

A “BOD member” may refer to an individual with substantive business or investment experience. The BOD member may not necessarily be technology proficient, but they may be proficient in basic computing skills. For instance, the BOD member may be qualified and/or skilled to use basic computer applications such as, but not limited to, an Office suite application, communication applications, cloud storage applications to conduct various business activities. Such a member may not necessarily be interested in investing excessive time on undesired topics in a BOD meeting except the desired content and discussion.

A “CEO” in the context of a BOD meeting may be a first time CEO or an experienced CEO. The BOD meeting environment may provide an environment, where the CEO is risk averse, cautious, and measured. The CEO may be technologically proficient or has sufficient qualification, skill, and/or technology support to make her or him technology enabled.

A “Chief Financial Officer (CFO)” may also be referred to as “Finance Leader” in the context of a BOD meeting. The CFO may be an individual with more or less experience than the CEO. The CFO may not necessarily be technology proficient and may not necessarily be willing to incur expenditure on technology unless the technology reduces time or company expenses. The CFO may have sufficient qualification and/or skill to be considered as an owner of a BOD presentation (e.g. a slide-deck) and may be required to perform majority activities in the BOD meeting. Without a CFO buy-in, new product adoption/technology may not be allowed in the BOD meeting.

An “Admin” may an individual who may be skilled in performing administrative activities. The personality of an Admin may vary significantly from person to person and may be diverse across demographics. The admin may be technology proficient in Office suite applications and communication-related applications.

The BOD meeting may also include several other members such as, but not limited to, a Chief Revenue Officer (CRO), Chief Procurement Officer (CPO), Chief Marketing Officer (CMO), a legal representative and a Human Resources representative.

A “buyer” may follow the same persona as the members in the BOD meeting such as, but not limited to, (a) investors in private companies and (b) the CEOs, CFOs, and Admins of the company. An important demand driver on Buyers is that a venture or private equity investor usually attends four to seven different BOD meetings every year with little to no standardization across companies for BOD meetings.

The system use a two-step or phase of CEO and management team process of strategy, scenario building and operating plan decisions that can be used for board of director meetings and decision making in a more dynamic, effective and efficient process. The system may have a two phased system that first focuses on CEO and management team strategic framing of the company's long term objectives and using the system capabilities to build scenarios and make internal decisions regarding investment and priorities. These conclusions based on the original workflows, vision, prompts, north stars and invest and scale system modules may then be used for the CEO and management to seamlessly integrate into a multiyear, multi horizon Board of Directors meetings, real-time decision scenarios, voting, proprietary messaging both public and private with a closed loop feedback and sentiment feature with stored artifacts via logs for a five to ten year Board member tenure.

In an embodiment, one or more computer-readable storage media may be used in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

The terms “comprising,” “including,” and “having,” as used in the claim and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition, or step being referred to is an optional (not required) feature of the invention.

The invention has been described with reference to various specific and preferred embodiments and techniques. However, many variations and modifications may be made while remaining within the spirit and scope of the invention. It will be apparent to one of ordinary skill in the art that methods, devices, device elements, materials, procedures, and techniques other than those specifically described herein can be applied to the practice of the invention as broadly disclosed herein without resort to undue experimentation. All art-known functional equivalents of methods, devices, device elements, materials, procedures, and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation. Additionally, the various embodiments of the networks, devices, and/or modules described herein contain optional features that can be individually or together applied to any other embodiment shown or contemplated here to be mixed and matched with the features of such networks, devices, and/or modules.

While the invention has been described with respect to a limited number of embodiments, those skilled in the art, having benefit of this disclosure, will appreciate that other embodiments can be devised which do not depart from the scope of the invention as disclosed herein.

I claim:

1. A computer-executable application for organizing a board of directors comprising:
a key metrics database and insights module that includes logic statements based on predetermined business logic;
a financial performance insights module that includes information about a user's company;
a comps metric module that includes data regarding companies that are not the user's company;
an analytics and insights module that compares information about the user's company to the data regarding companies that are not the user's company, and provides reports regarding same;
a board of directors module that organizes board meetings; and
a user interface module that allows a user to access the key metrics and insights database module, financial performance insights module, comps metric module, analytics and insights module, and board of directors module.

2. The computer-executable application for organizing a board of directors of claim 1, wherein the board of directors module allows a user to calendar, set tasks, access board book builder and templates, review board meetings organization, and conduct board meetings.

3. The computer-executable application for organizing a board of directors of claim 1, wherein the user interface module authenticates user credentials associated with accessing or denying access to features within the key metrics and insights database module, financial performance insights module, comps metric module, analytics and insights module, and board of directors module.

4. The computer-executable application for organizing a board of directors of claim 1, wherein the logic statements can be created and changed by users.

5. The computer-executable application for organizing a board of directors of claim 1, wherein application can select one or more Northstar comparison companies selected from the companies that are not the user's company.

6. The computer-executable application for organizing a board of directors of claim 5, wherein the analytics and insights module compares the user's company to one or more Northstar comparison companies.

7. The computer-executable application for organizing a board of directors of claim 6, wherein the comparison compares financial performance.

8. The computer-executable application for organizing a board of directors of claim 1, wherein the data regarding companies that are not the user's company is fed by internet crawlers.

9. The computer-executable application for organizing a board of directors of claim 8, wherein the data regarding companies that are not the user's company is fed by an EDGAR database.

10. The computer-executable application for organizing a board of directors of claim 1, wherein the board of directors module allows a user to set up a video conference.

11. The computer-executable application for organizing a board of directors of claim 1, wherein the board of directors module allows a user to conduct polls of other users.

12. The computer-executable application for organizing a board of directors of claim 1, wherein the board of directors module allows a user to assign tasks to other users.

13. The computer-executable application for organizing a board of directors of claim 1, wherein the board of directors module allows a user with permissions to set a vision the user company.

14. The computer-executable application for organizing a board of directors of claim 1, wherein the board of directors module includes a specific company module for organizing meetings.

15. The computer-executable application for organizing a board of directors of claim 14, wherein organizing meetings includes granting users an ability to assign tasks to other users in preparation for a meeting.

16. The computer-executable application for organizing a board of directors of claim 1,
wherein the application creates a log of decisions taken at meetings.

17. The computer-executable application for organizing a board of directors of claim 16, wherein the decisions taken at meetings are done using a survey during the meetings, wherein the application operates the surveys.

18. The computer-executable application for organizing a board of directors of claim 1, further comprising an accounts module gives users an opportunity to take notes in a journal.

19. The computer-executable application for organizing a board of directors of claim 1, further including a performance module that allows uploading and storage of company data.

20. The computer-executable application for organizing a board of directors of claim 19, wherein the data is financial data that can be compared to other company financial data.
